(19) United States
(12) Patent Application Publication
(10) Pub. No.: US 2014/0238255 A1
(43) Pub. Date: Aug. 28, 2014

(54) RESIN COMPOSITION FOR LASER ENGRAVING, FLEXOGRAPHIC PRINTING PLATE PRECURSOR FOR LASER ENGRAVING AND PROCESS FOR PRODUCING SAME, AND FLEXOGRAPHIC PRINTING PLATE AND PROCESS FOR MAKING SAME

(71) Applicant: FUJIFILM Corporation, Tokyo (JP)

(72) Inventor: Atsushi SUGASAKI, Shizuoka (JP)

(73) Assignee: FUJIFILM Corporation, Tokyo (JP)

(21) Appl. No.: 14/186,167

(22) Filed: Feb. 21, 2014

(30) Foreign Application Priority Data
Feb. 22, 2013 (JP) 2013-033773

(51) Int. Cl. B29C 59/16; B41N 1/00

(52) U.S. Cl. CPC B29C 59/16; B41N 1/00
USPC 101/395; 525/450; 525/291; 522/2; 264/400

(57) ABSTRACT

Disclosed is a resin composition for laser engraving, comprising (Component A) a binder polymer and (Component B) a crosslinking agent, and a crosslinked relief-forming layer formed from the composition being depolymerizable. Component A preferably comprises (Component A-1) a depolymerizable binder polymer. Component A-1 preferably comprises any one selected from the group consisting of a polyester resin, a resin containing at least 50 mol % of a (meth)acrylic acid ester as a monomer unit, and a resin containing at least 50 mol % of α-methylstyrene as a monomer unit.

### CROSS REFERENCE TO RELATED APPLICATIONS

This application claims priority under U.S.C. 119 from Japanese Patent Application No. 2013-033773 filed on Feb. 22, 2013, the entire contents of which are incorporated by reference herein.

### TECHNICAL FIELD

The present invention relates to a resin composition for laser engraving, a flexographic printing plate precursor for laser engraving and a process for producing the same, and a flexographic printing plate and a process for making the same.

### BACKGROUND ART

A large number of so-called “direct engraving CTP methods”, in which a relief-forming layer is directly engraved by means of a laser are proposed. In the method, a laser light is directly irradiated to a flexographic printing plate precursor to cause thermal decomposition and volatilization by photothermal conversion, thereby forming a concave part. Differing from a relief formation using an original image film, the direct engraving CTP method can control freely relief shapes. Consequently, when such image as an outline character is to be formed, it is also possible to engrave that region deeper than other regions, or, in the case of a fine halftone dot image, it is possible, taking into consideration resistance to printing pressure, to engrave while adding a shoulder. With regard to the laser for use in the method, a high-power carbon dioxide laser is generally used. In the case of the carbon dioxide laser, all organic compounds can absorb the irradiation energy and convert it into heat. On the other hand, inexpensive and small-sized semiconductor lasers have been developed, wherein, since they emit visible lights and near infrared lights, it is necessary to absorb a laser light and convert it into heat.

As a resin composition for laser engraving, those described in JP-A-2010-253931 (JP-A denotes a Japanese unexamined patent application publication), JP-A-2008-106213, JP-A-2009-255510, or JP-A-2012-116008 are known.

### DISCLOSURE OF THE PRESENT INVENTION

### Problems that the Present Invention is to Solve

It is an object of the present invention to provide a resin composition for laser engraving that can give an excellent flexographic printing plate having high engraving sensitivity, a suppressed amount of engraving residue, and good rinsing properties for engraving residue, a flexographic printing plate precursor and a process for producing same using the resin composition for laser engraving, a process for making a flexographic printing plate using the flexographic printing plate precursor, and a flexographic printing plate obtained thereby.

### Means for Solving the Problems

The object of the present invention has been attained by means described in <1>, <15>, <16>, <18> and <19> below. They are described below together with <2> to <14> and <17>, which are preferred embodiments.

<1> a resin composition for laser engraving, comprising: (Component A) a binder polymer, and (Component B) a crosslinking agent, a crosslinked relief-forming layer formed from the composition being depolymerizable,
<2> the resin composition for laser engraving according to <1>, wherein Component A comprises (Component A-1) a depolymerizable binder polymer.
<3> the resin composition for laser engraving according to <2>, wherein Component A-1 comprises any one selected from the group consisting of a polyester resin, a resin containing at least 50 mol % of a (meth)acrylic acid ester as a monomer unit, and a resin containing at least 50 mol % of α-methylstyrene as a monomer unit.
<4> the resin composition for laser engraving according to <2> or <3>, wherein Component A-1 is selected from the group consisting of polylactic acid, a poly(methyl methacrylate)-b-poly(butyl acrylate)-b-poly(methyl methacrylate) block copolymer, a poly(α-methylstyrene)-b-poly(butyl acrylate)-b-poly(α-methylstyrene) block copolymer, poly(methyl methacrylate), a methyl methacrylate/2-hydroxyethyl methacrylate copolymer, a methyl methacrylate/allyl methacrylate copolymer, poly(methyl acrylate), a methyl acrylate/2-hydroxyethyl acrylate copolymer, and a methyl acrylate/allyl methacrylate copolymer,
<5> the resin composition for laser engraving according to any one of <2> to <4>, wherein Component B comprises (Component B-1) a depolymerizable crosslinking agent.
<6> the resin composition for laser engraving according to <5>, wherein Component B-1 comprises as a crosslinkable group at least one type of group selected from the group consisting of —SiR¹R²R³, an acid anhydride residue, an ethylenically unsaturated group, an isocyanate group, a blocked isocyanate group, an amino group, a hydroxy group, —C(═O)—R⁴, an epoxy group, a carboxylic acid group, and a mercapto group,
<7> the resin composition for laser engraving according to <5> or <6>, wherein Component A-1 and Component B-1 have a content in total of 80 to 99 mass % of the total solids content of the resin composition for laser engraving,
<8> the resin composition for laser engraving according to any one of <5> to <7>, wherein Component B-1 has a content of 5 to 90 mass % of the total solids content of the resin composition for laser engraving,
<9> the resin composition for laser engraving according to any one of <1> to
<8>, wherein it further comprises (Component C) a photothermal conversion agent,
<10> the resin composition for laser engraving according to <9>, wherein Component C comprises a group that can form a covalent bond with Component A and/or Component B,
<11> the resin composition for laser engraving according to <9> or <10>, wherein Component C is carbon black,
<12> the resin composition for laser engraving according to any one of <9> to <11>, wherein Component C has a content of no greater than 10 mass % of the total solids content of the resin composition for laser engraving,
<13> the resin composition for laser engraving according to any one of <1> to <12>, wherein it further comprises (Component D) a crosslinking catalyst,
<14> the resin composition for laser engraving according to any one of <1> to <13>, wherein it further comprises (Component E) a depolymerization catalyst and/or a depolymerization catalyst precursor,
<15> a flexographic printing plate precursor for laser engraving, comprising a crosslinked relief-forming layer formed by crosslinking by means of light and/or heat a relief-forming layer formed from the resin composition for laser engraving according to any one of <1> to <14>,
<16> a process for producing a flexographic printing plate precursor for laser engraving, the process comprising: a layer formation step of forming a relief-forming layer from the resin composition for laser engraving according to any one of <1> to <14>, and a crosslinking step of crosslinking the relief-forming layer by means of light and/or heat to thus obtain a flexographic printing plate precursor comprising a crosslinked relief-forming layer,
<17> the process for producing a flexographic printing plate precursor for laser engraving according to <16>, wherein the crosslinking step is a step of crosslinking the relief-forming layer by means of heat to thus obtain a flexographic printing plate precursor comprising a crosslinked relief-forming layer,
<18> a process for making a flexographic printing plate, the process comprising in order: a step of preparing a flexographic printing plate precursor for laser engraving comprising a crosslinked relief-forming layer formed by crosslinking by means of light and/or heat a relief-forming layer formed from the resin composition for laser engraving according to any one of <1> to <14>, and an engraving step of laser engraving the crosslinked relief-forming layer to thus form a relief layer,
<19> a flexographic printing plate comprising a relief layer, the flexographic printing plate being made by the process for making a flexographic printing plate according to <18>.

### Effects of the Invention

In accordance with the present invention, there can be provided a resin composition for laser engraving that can give an excellent flexographic printing plate having high engraving sensitivity, a suppressed amount of engraving residue, and good rinsing properties for engraving residue, a flexographic printing plate precursor and a process for producing same using the resin composition for laser engraving, a process for making a flexographic printing plate using the flexographic printing plate precursor, and a flexographic printing plate obtained thereby.

### MODE FOR CARRYING OUT THE INVENTION

The present invention is explained in detail below.

In the present specification, the notation ‘xx to yy’ means a numerical range that includes xx and yy. Furthermore, ‘(Component A) binder polymer’, etc. is also simply called ‘Component A’, etc.

The term ‘(meth)acrylate’, etc. has the same meaning as ‘acrylate and/or methacrylate’, etc., and the same applies below.

Furthermore, in the present invention, ‘mass %’ and ‘wt %’ have the same meaning, and ‘parts by mass’ and ‘parts by weight’ have the same meaning.

Moreover, in the present invention a combination of the preferred embodiments explained below is a more preferred embodiment.

### (Resin Composition for Laser Engraving)

The resin composition for laser engraving of the present invention (hereinafter, also simply called a ‘resin composition’) comprises (Component A) a binder polymer and (Component B) a crosslinking agent, a crosslinked relief-forming layer formed from the composition being depolymerizable.

In addition to application in a relief-forming layer of a flexographic printing plate precursor that is subjected to laser engraving, the resin composition for laser engraving of the present invention may be used, without any particular limitations, in a wide range of applications. For example, it may be applied not only to a relief-forming layer of a printing plate precursor in which formation of a raised relief, which is described in detail below, is carried out by laser engraving but also to formation of other material shapes forming asperities and openings on the surface, for example, various types of printing plates and various types of moldings in which image formation is carried out by laser engraving, such as an intaglio plate, a stencil plate, or a stamp.

Among them, a preferred mode is application to formation of a relief-forming layer provided on an appropriate support.

The mechanism of action in the resin composition of the present invention is surmised to be as follows.

Due to the crosslinked relief-forming layer formed from the composition comprising Component A and Component B being depolymerizable in its entirety, compared with the so-called thermal decomposition, decomposition progresses with lower energy as a result of depolymerization of the binder polymer and the crosslinking agent. It is surmised that this enables high engraving sensitivity to be obtained.

Furthermore, it is thought that the depolymerization leads to decomposition of Component A and Component B to the monomer level. It is surmised that because of this the amount of engraving residue remaining on a plate surface after engraving is greatly reduced and engraving residue generated on the plate surface has excellent rinsing properties. That is, the total amount of engraving residue is the total amount of (1) the amount of engraving residue decomposed to the gas level and (2) the amount of engraving residue becoming attached to and remaining on a printing plate in a liquid or solid form. The engraving residue of (1) above is removed and/or collected by a dust collection system mounted on an engraving machine. On the other hand, the engraving residue of (2) is washed away with a rinsing liquid. In the present invention, introducing a decomposition mechanism mainly involving depolymerization allows the amount of engraving residue (1) to be greatly increased and the amount of engraving residue (2) to be correspondingly reduced.

Moreover, as a result of an intensive investigation, the present inventors have found that (i) the smaller the amount of engraving residue remaining on a plate surface and (ii) the higher the hydrophilicity of the engraving residue remaining on the plate surface, the better the rinsing properties (the lower the amount of engraving residue) for engraving residue on the printing plate in a liquid or solid form. Conventionally, rinsing properties are improved from the viewpoint of (ii), and it has been reported that, for example, rinsing properties are improved by adding a silane coupling agent to a resin composition for a relief-forming layer. In the present invention, the amount of engraving residue remaining on the plate surface is also to be reduced from the viewpoint of (i).

Furthermore, when (Component C) a photothermal conversion agent that contains a group that is copolymerizable with Component A and/or Component B is used in combination, it is thought that the photothermal conversion agent behaves as a kind of crosslinking site. In this case, it is surmised that due to the photothermal conversion agent functioning as a site to trigger depolymerization, higher engraving sensitivity can be obtained, the generation of engraving residue is further suppressed and, furthermore, rinsing properties for engraving residue that has been generated are better.

Furthermore, when (Component C) a photothermal conversion agent that contains a group that is copolymerizable with Component A and/or Component B is used in combination, it is thought that the photothermal conversion agent behaves as a kind of crosslinking site. In this case, it is surmised that due to the photothermal conversion agent functioning as a site to trigger depolymerization, higher engraving sensitivity can be obtained, the generation of engraving residue is further suppressed and, furthermore, rinsing properties for engraving residue that has been generated are better.

In the present specification, with respect to an explanation of the flexographic printing plate precursor, a non-crosslinked crosslinkable layer comprising Component A to Component B and having a flat surface as an image formation layer that is subjected to laser engraving is called a relief-forming layer, a layer that is formed by crosslinking the relief-forming layer is called a crosslinked relief-forming layer, and a layer that is formed by subjecting this to laser engraving so as to form asperities on the surface is called a relief layer.

Components contained in the resin composition for laser engraving of the present invention are explained below.

### (Component A) Binder Polymer

The resin composition for laser engraving of the present invention comprises (Component A) a binder polymer.

Here, the crosslinked relief-forming layer formed from the resin composition for laser engraving of the present invention is depolymerizable.

The depolymerization referred to here means a reaction corresponding to a phenomenon in which a polymer decomposes to monomer, that is, the reverse of a polymerization reaction.

In the present invention, the ‘crosslinked relief-forming layer formed from the composition being depolymerizable’ means a case in which (1) gaseous residue and (2) solid or liquid engraving residue remaining on the printing plate, which are generated when laser engraving the crosslinked relief-forming layer, crosslinked by means of heat and/or light, using a carbon dioxide Laser Marker after solvent has been removed from the layer of the resin composition for laser engraving of the present invention as necessary, are analyzed and the proportion of starting monomer or cyclic oligomer of monomer is at least 50 mass % of the total mass of the residue. The gaseous residue (1) can be quantitatively analyzed using gas chromatography by collecting gas with a gas collection bag placed in the vicinity of the printing plate precursor while engraving. Furthermore, the solid or liquid engraving residue remaining on the printing plate (2) can be quantitatively analyzed using high performance liquid chromatography by dissolving it in an appropriate solvent after collection.

In the present invention, in order to render a crosslinked relief-forming layer formed from the composition depolymerizable, it is preferable to use (Component A-1) a depolymerizable binder polymer as the binder polymer (Component A) and, as described later, (Component B-1) a depolymerizable crosslinking agent as the crosslinking agent (Component B).

Here, the binder polymer being depolymerizable is determined as follows. (1) When the binder polymer is a solid, the binder polymer is dissolved in a good solvent, applied onto a metal substrate such as aluminum and dried to form a film, or melt-pressed to form a film, and the film is irradiated with a carbon dioxide laser. (2) When the binder polymer is a liquid or a high viscosity oil, the binder polymer is poured into a metal container (e.g. a shallow aluminum cup) and is directly irradiated with a carbon dioxide laser. When the gaseous residue (1) and the remaining solid or liquid engraving residue (2), which are generated when irradiating (laser-engraving) with a laser from a carbon dioxide Laser Marker, are individually analyzed, if the proportion of starting monomers and cyclic oligomer of these monomers is at least 50 mass % of the total mass of the residue, the binder polymer is defined as being depolymerizable.

Furthermore, Component A is a polymer and has a weight-average molecular weight of at least 10,000. From the viewpoint of ink transfer properties at the time of printing, the weight-average molecular weight is preferably 10,000 to 300,000, more preferably 10,000 to 250,000, and yet more preferably 10,000 to 150,000.

In the present invention the weight-average molecular weight may be measured by a gel permeation chromatography method (GPC method) and converted using a polystyrene with a known molecular weight.

Component A preferably comprises (Component A-1) a depolymerizable binder polymer.

Component A-1 preferably comprises in the molecular chain, as a monomer unit that easily decomposes, styrene, α-methylstyrene, α-methoxystyrene, an acrylic acid ester, a methacrylic acid ester, an ester compound, an ether compound, a nitro compound, a carbonate compound, a carbamoyl compound, a hemiacetal ester compound, an oxyethylene compound, an aliphatic cyclic compound, etc. Specific examples thereof include a poly(α-methylstyrene), a poly(atropic acid ester), a poly(α-acetoxystyrene), a poly(o-methoxystyrene), a polyaldehyde, a poly((meth)acrylic acid ester) whose ceiling temperature has been decreased, a poly(tetrahydrofuran), a poly-δ-caprolactam, which is a polymer of a 2-piperidone monomer, a poly-γ-caprolactam, which is a polymer of a 2-pyrrolidone monomer, a polyallyl acetate, a polyallyl alcohol, a polyallyl ether, a polybutene, a polyhexene, a polyoxepane, and a polyoxyalkylene polymer.

Component A-1 is preferably an addition polymer of an ethylenically unsaturated compound, or a polyester. The addition polymer may be a random polymer or a block copolymer and is not particularly limited. In the explanation below, a block copolymer is expressed in a form in which blocks are delimited with ‘-b-’, and a copolymer without any particular explanation is a random copolymer.

The addition polymer is preferably an addition polymer formed by polymerization of a (meth)acrylic acid ester and/or α-methylstyrene as monomers, and is more preferably an addition polymer formed by polymerization of a (meth)acrylic acid ester or α-methylstyrene as a monomer.

When the total amount of monomer units forming the addition polymer is 100 mol %, the (meth)acrylic acid ester or α-methylstyrene is preferably contained at at least 50 mol %, more preferably at least 65 mol %, and yet more preferably at least 75 mol %.

It is preferable to use the monomers in the above configuration since the engraving sensitivity is excellent and engraving residue is suppressed.

The (meth)acrylic acid ester is preferably an alkyl (meth)acrylate. The alkyl group may be straight-chain or branched and is preferably an alkyl group having 1 to 20 carbons, more preferably an alkyl group having 1 to 12 carbons, and yet more preferably an alkyl group having 1 to 8 carbons. Specific examples include methyl (meth)acrylate, ethyl (meth)acrate, n-propyl (meth)acrylate, isopropyl (meth)acrylate, n-butyl (meth)acrylate, isobutyl (meth)acrylate, tert-butyl (meth)acrylate, hexyl (meth)acrylate, octyl (meth)acrylate, and 2-ethylhexyl (meth)acrylate; among them methyl (meth)acrylate is more preferable, and methyl methacrylate is particularly preferable.

Furthermore, examples of other (meth)acrylic acid esters include 2-hydroxyethyl (meth)acrylate, 2-hydroxypropyl (meth)acrylate, 4-hydroxybutyl (meth)acrylate, acetoxyethyl (meth)acrylate, phenyl (meth)acrylate, 2-methoxyethyl (meth)acrylate, 2-ethoxyethyl (meth)acrylate, 2-(2-methoxyethoxy)ethyl (meth)acrylate, cyclohexyl (meth)acrylate, benzyl (meth)acrylate, diethylene glycol monomethyl ether (meth)acrylate, diethylene glycol monoethyl ether (meth)acrylate, diethylene glycol monophenyl ether (meth)acrylate, triethylene glycol monomethyl ether (meth)acrylate, triethylene glycol monoethyl ether (meth)acrylate, dipropylene glycol monomethyl ether (meth)acrylate, polyethylene glycol monomethyl ether (meth)acrylate, polypropylene glycol monomethyl ether (meth)acrylate, a monomethyl ether (meth)acrylate of a copolymer between ethylene glycol and propylene glycol, N,N-dimethylaminoethyl (meth)acrylate, N,N-diethylaminoethyl (meth)acrylate, N,N-dimethylaminopropyl (meth)acrylate, and allyl (meth)acrylate.

Furthermore, the polyester may be obtained by polycondensation of a polybasic acid (polycarboxylic acid) and a polyhydric alcohol or polycondensation of a hydroxy acid and as necessary a polybasic acid and a polyhydric alcohol.

Examples of the polyol include ethylene glycol, diethylene glycol, triethylene glycol, 1,2-propylene glycol, 1,4-butanediol, 1,6-hexanediol, neopentyl glycol, 1,3-butylene glycol, tetramethylene glycol, hexamethylene glycol, decamethylene glycol, octanediol, tricyclodecanedimethylol, cyclohexanediol, cyclohexanedimethanol, xylylenedimethanol, hydrogenated bisphenol A, bisphenol A polyethylene glycol ether, bisphenol A polypropylene glycol ether, an ethylene oxide or propylene oxide adduct of bisphenol A, an ethylene oxide or propylene oxide adduct of hydrogenated bisphenol A, glycerol, trimethylolethane, trimethylolpropane, diglycerol, pentaerythritol, dipentaerythritol, and sorbitol.

Examples of the polybasic acid include isophthalic acid, malonic acid, succinic acid, adipic acid, azelaic acid, sebacic acid, maleic acid, fumaric acid, and dimer acid.

Examples of the hydroxy acid include glycolic acid, lactic acid, tartronic acid, glyceric acid, hydroxybutyric acid, malic acid, tartaric acid, citramalic acid, citric acid, isocitric acid, leucic acid, mevalonic acid, pantoic acid, ricinoleic acid, ricinelaidic acid, cerebronic acid, quinic acid, shikimic acid, salicylic acid, creotic acid, vanillic acid, and syringic acid.

Examples of polyesters obtained from a hydroxy acid include polylactic acid, a polyhydroxyalkanoate, polyglycolic acid, polycaprolactone, polybutylenesuccinic acid, and derivatives or mixtures thereof.

Among them, the polyester is preferably polylactic acid.

When a polyester, such as polylactic acid, obtained from a hydroxy acid is subjected to depolymerization, there is a case in which, instead of lactic acid, which is the starting monomer, a lactide, which is a cyclic oligomer of lactic acid, is formed. In the present invention, such a reaction also corresponds to depolymerization.

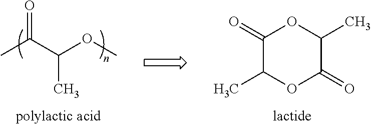

In the present invention, examples of Component A-1 include polylactic acid, a poly(methyl methacrylate)-b-poly(butyl acrylate)-b-poly(methyl methacrylate) block copolymer, a poly(α-methylstyrene)-b-poly(butyl acrylate)-b-poly(α-methylstyrene) block copolymer, poly(methyl methacrylate), a methyl methacrylate/2-hydroxyethyl methacrylate copolymer (methyl methacrylate content being at least 75 mol %), a methyl methacrylate/allyl methacrylate copolymer (methyl methacrylate content being at least 75 mol %), poly(methyl acrylate), poly(methyl methacrylate), a methyl acrylate/2-hydroxyethyl acrylate copolymer (methyl acrylate content being at least 75 mol %), and poly(α-methylstyrene). Among them, polylactic acid, a poly(methyl methacrylate)-b-poly(butyl acrylate)-b-poly(methyl methacrylate) block copolymer, poly(α-methylstyrene), and a poly(α-methylstyrene)-b-poly(butyl acrylate)-b-poly(α-methylstyrene) block copolymer are preferable, and polylactic acid is particularly preferable.

Component A-1 preferably has a glass transition temperature of no greater than 150° C., more preferably no greater than 100° C., and yet more preferably no greater than 80° C. There are no particular restrictions on a lower limit for the glass transition temperature.

It is preferable for the glass transition temperature to be in this range since it is easy to mold a relief-forming layer and a crosslinked film thus obtained has excellent flexibility.

In the present invention, glass transition temperature may be measured by differential scanning calorimetric measurement (DSC measurement). Specifically, 10 mg of a sample is placed in a measurement pan and heated in a flow of nitrogen from −50° C. to 180° C. at 10° C./min (1st run), then cooled to −50° C. at 10° C./min, and subsequently heated again from −50° C. to 180° C. at 10° C./min (2nd run), the temperature at which the base line starts to be displaced from the low temperature side in the 2nd run being defined as the glass transition temperature (Tg).

With regard to Component A-1, the resin composition may comprise one type thereof or may comprise two or more types thereof.

The content of Component A-1 in the resin composition is preferably 5 to 90 mass % of the total solids content, more preferably 15 to 85 mass %, and yet more preferably 30 to 80 mass %. It is preferable for the content of Component A to be in the above range since a relief layer having excellent engraving sensitivity, suppressed generation of engraving residue, and excellent rinsing properties for engraving residue is obtained. The solids content of the resin composition referred to here means the amount excluding volatile components such as solvent.

The resin composition for laser engraving of the present invention may comprise (Component A-2) a binder polymer that is not depolymerizable (resin component). Examples of such a binder polymer include nonelastomers described in JP-A-2011-136455 and unsaturated group-containing polymers described in JP-A-2010-208326.

The resin composition for laser engraving of the present invention preferably comprises the depolymerizable binder polymer (Component A-1) as a main component of the binder polymer (Component A), and when it comprises another binder polymer, the content of Component A-1 relative to the entire Component A is preferably at least 60 mass %, more preferably at least 70 mass %, and yet more preferably at least 80 mass %. The upper limit is not particularly restricted, but is preferably 100 mass %, that is, it comprises only the depolymerizable binder polymer as the binder polymer. When it comprises another binder polymer, the content of the depolymerizable binder polymer is preferably no greater than 99 mass %, more preferably no greater than 97 mass %, and yet more preferably no greater than 95 mass %.

### (Component B) Crosslinking Agent

The resin composition for laser engraving of the present invention comprises (Component B) a crosslinking agent. In the present invention, it is preferable for it to comprise (Component B-1) a depolymerizable crosslinking agent as Component B. In the explanation below, when referring simply to a ‘crosslinking agent’, it means collectively (Component B-1) a depolymerizable crosslinking agent and (Component B-2) another crosslinking agent.

Here, the crosslinking agent being depolymerizable is determined in the same manner as for the binder polymer being depolymerizable. Specifically, as described above, (1) when the crosslinking agent is a solid, the crosslinking agent is dissolved in a good solvent, applied onto a metal substrate such as aluminum and dried to form a film, or melt-pressed to form a film, and the film is irradiated with a carbon dioxide laser. (2) When the crosslinking agent is a liquid or a high viscosity oil, the crosslinking agent is poured into a metal container (e.g. a shallow aluminum cup) and is directly irradiated with a carbon dioxide laser. When the gaseous residue (1) and the remaining solid or liquid engraving residue (2), which are generated when irradiating (laser-engraving) with a laser from a carbon dioxide Laser Marker, are individually analyzed, if the proportion of starting monomers and cyclic oligomer of these monomers is at least 50 mass % of the total mass of the residue, the crosslinking agent is defined as being depolymerizable.

Examples of Component B-1 that can be used in the present invention are not particularly limited as long as they can be crosslinked and are depolymerizable, and known compounds may be used.

### (Component B-1) Depolymerizable Crosslinking Agent

Component B comprises a crosslinkable group. The crosslinkable group of Component B is not particularly limited as long as it can form any crosslinking selected from the group consisting of crosslinking between Component B molecules, crosslinking between Component A and Component B, and crosslinking between Component B and another crosslinking agent. Among them, it is preferable for it to be able to form at least crosslinking between Component B molecules. That is, Component B-1 preferably comprises a functional group that enables Component B-1 molecules to crosslink with each other.

As the crosslinkable group, at least one type of group selected from the group consisting of —SiR¹R²R³, an acid anhydride residue, an ethylenically unsaturated group, an isocyanate group, a blocked isocyanate group, an amino group, a hydroxy group, —C(═O)—R⁴, an epoxy group, a carboxylic acid group (carboxy group), and a mercapto group can be cited preferably.

R¹ to R³ in —SiR¹R²R³ independently denote a hydrogen atom, a halogen atom, or a monovalent organic group, and among R¹ to R³ at least one is an alkyl group, an alkoxy group, or a halogen atom. Furthermore, R⁴ of —C(═O)—R⁴ denotes a hydrogen atom or an alkyl group.

Preferred examples of the ethylenically unsaturated group include a methacryloyl group, an acryloyl group, a styryl group, and a vinyloxy group.

Furthermore, the blocked isocyanate group referred to here means a group that is formed by reacting an isocyanate group and a blocking agent and that can decompose upon heating to thus regenerate an isocyanate group. Examples of the blocking agent include an alcohol compound, a cyclic amide compound, a ketoxime compound, a phenol compound, and a secondary amine compound. Furthermore, as the blocked isocyanate group, Japanese registered patent No. 3095227 may also be referred to. The temperature at which an isocyanate group is regenerated from the blocked isocyanate group is not particularly limited and may be selected according to the structure of the blocked isocyanate group.

Specific examples of a reaction that forms crosslinking include a reaction between an isocyanate group and a group having an active hydrogen, such as a hydroxy group, an amino group, or a mercapto group, a reaction between a carboxy group and a hydroxy group or amino group, a reaction between an epoxy group and a hydroxy group or amino group, a reaction between ethylenically unsaturated groups, a reaction between hydrolyzable silyl groups, a reaction between silanol groups, and a reaction between a hydrolyzable silyl group and a silanol group, but the present invention is not limited thereto.

Among them, Component B-1 is preferably selected from the group consisting of a compound having at least two (preferably 2 to 6, more preferably 2 to 4, yet more preferably 2 or 3, and particularly preferably 2) isocyanate groups and at least two (preferably 2 to 6, more preferably 2 to 4, yet more preferably 2 or 3, and particularly preferably 2) groups selected from the group consisting of a hydroxy group and an amino group, a compound having at least two (preferably 2 to 6, more preferably 2 to 4, yet more preferably 2 or 3, and particularly preferably 2) ethylenically unsaturated groups, and a compound having at least two (preferably 2 to 6, more preferably 2 to 4, yet more preferably 2 or 3, and particularly preferably 2) hydroxy groups and at least two (preferably 2 to 6, more preferably 2 to 4, yet more preferably 2 or 3, and particularly preferably 2) carboxy groups.

The weight-average molecular weight of Component B-1 is less than 10,000, preferably at least 1,000 but less than 10,000, more preferably at least 2,000 but less than 10,000, and yet more preferably at least 5,000 but less than 10,000.

It is preferable for the molecular weight of Component B-1 to be in this range since an engraved shape is good.

Component B-1 preferably has a low glass transition temperature (Tg), and it is more preferably no greater than room temperature (20° C.), yet more preferably no greater than 10° C., and particularly preferably no greater than 0° C. The lower limit of the glass transition temperature is not particularly restricted.

It is preferable for the glass transition temperature to be no greater than room temperature since Component B has a function as a plasticizer and can give a flexible crosslinked relief-forming layer without separately adding a plasticizer even when the glass transition temperature of Component A is room temperature or greater. Furthermore, adding no plasticizer is preferable since there is no problem with contamination, etc. of a plate surface due to bleeding out of plasticizer.

On the other hand, when the glass transition temperature of Component B-1 exceeds room temperature and the molecular weight is less than 1,000, or Component B-1 is a solid at room temperature, if the glass transition temperature of Component A is room temperature or greater, the glass transition temperature of a crosslinked film (crosslinked relief-forming layer) becomes room temperature or greater, and there is a case in which the resilience (rubber resilience) necessary as a relief layer cannot be exhibited. In such a case, it is preferable to add a plasticizer described below, thereby setting the glass transition temperature of a crosslinked film (crosslinked relief-forming layer) at no greater than room temperature.

In the present invention Component B-1 is preferably a compound in which the crosslinkable group is introduced to a polymer having a molecular weight of at least 1,000. That is, Component B-1 is preferably a compound having a polymer moiety containing a repeating unit and a crosslinkable group-containing moiety containing a crosslinkable group, the crosslinkable group-containing moiety being preferably present at both termini of a main chain of the polymer moiety.

The content of the polymer moiety in Component B is preferably 40 to 99 mass %, more preferably 50 to 99 mass %, and yet more preferably 60 to 99 mass %. It is preferable for the content of the polymer moiety in Component B to be in this range since engraving sensitivity improves.

In the present invention, it is preferable that the main backbone structure of Component A is similar to that of Component B. That is, it is preferable that the main backbone structure of the polymer moiety of Component B is similar to the main backbone structure of Component A. Due to the main backbone structures of Component A and Component B being similar, compatibility with Component A improves, as a result degradation in the film strength (breaking strength or elongation at break) due to micro phase separation between Component A and Component B is suppressed, and high abrasion resistance is obtained, which is preferable.

For example, when Component A is a polymer obtained by addition polymerization of an ethylenically unsaturated compound, the polymer moiety of Component B preferably has a structure in which at least several ethylenically unsaturated compounds of the same type are linked. Furthermore, when Component A is for example a polyester, the polymer moiety of Component B preferably has a polyester structure containing a plurality of ester bonds in the molecular structure, and more preferably has the same type of repeating unit as in Component A.

In particular, when Component A comprises at least 50 mole % of a methyl methacrylate-derived monomer unit, the polymer moiety of Component B preferably comprises a methyl methacrylate-derived repeating unit. Furthermore, when Component A comprises at least 50 mole % of an α-methylstyrene-derived monomer unit, the polymer moiety of Component B preferably comprises an α-methylstyrene-derived repeating unit. Moreover, when Component A is a polyester resin comprising at least 50 mole % of lactic acid as a polycondensation component, the polymer moiety of Component B preferably comprises a lactic acid-derived repeating unit.

In addition, the repeating unit of Component B that is of the same type as that of Component A is preferably at least 10 mass % of the entire Component B, more preferably at least 30 mass %, and yet more preferably at least 50 mass %. It is preferable for the repeating unit of the same type to be in this range since engraving sensitivity is excellent, the generation of engraving residue is suppressed, and rinsing properties for engraving residue are excellent.

That is, when Component A is polylactic acid, Component B is preferably a polyester comprising a lactic acid-derived repeating unit, and the proportion of the lactic acid-derived repeating unit is preferably at least 10 mass % of the entire Component B, more preferably at least 30 mass %, and yet more preferably at least 50 mass %.

Furthermore, when Component A is a poly(methyl methacrylate)-b-poly(butyl acrylate)-b-poly(methyl methacrylate) block copolymer, Component B preferably comprises a methyl methacrylate- and/or butyl acrylate-derived repeating unit, and the proportion of the methyl methacrylate- and/or butyl acrylate-derived repeating unit is preferably at least 10 mass % of Component B, more preferably at least 30 mass %, and yet more preferably at least 50 mass %.

Specific preferred examples of Component B include (B-1) to (B-3) below, but the present invention should not be construed as being limited thereto.

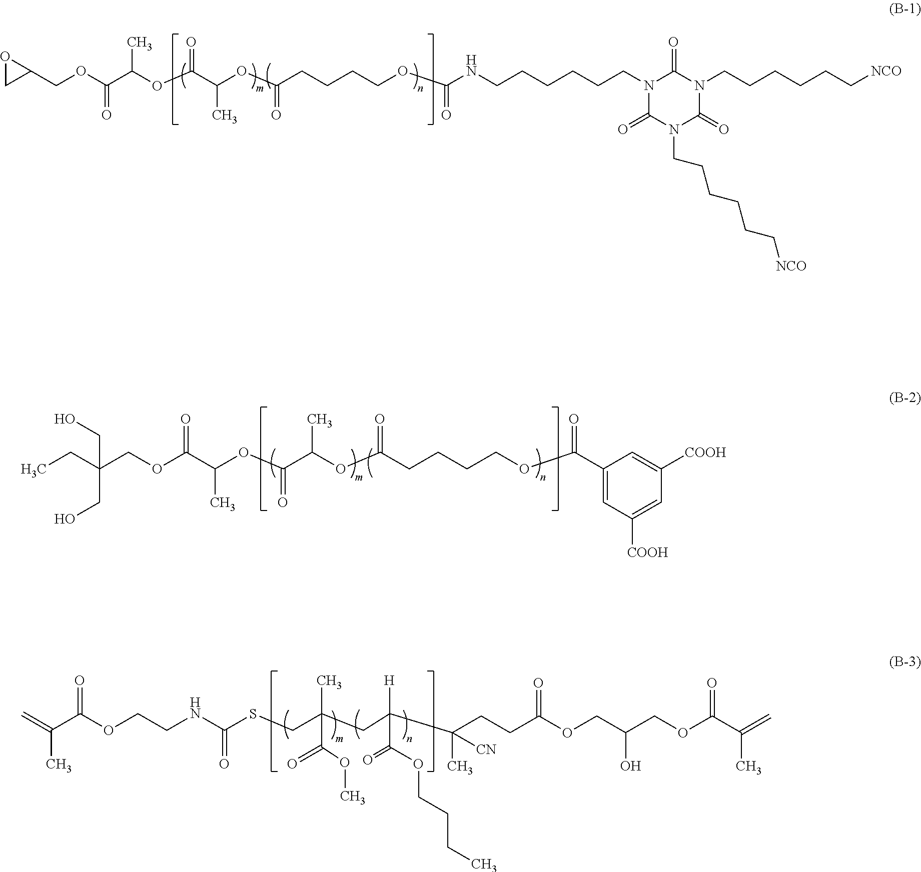

In (B-1) to (B-3), n and m denote repeating unit molar proportions, n+m=100 is satisfied, and n:m is preferably 50:50 to 100:0.

The content of Component B-1 contained in the resin composition for laser engraving is preferably 1 to 95 mass % of the total solids content, more preferably 5 to 90 mass %, yet more preferably 15 to 75 mass %, and particularly preferably 30 to 70 mass %. It is preferable for it to be in this range since engraving sensitivity is excellent, the generation of engraving residue is suppressed, and rinsing properties for engraving residue are excellent.

In addition, the resin composition for laser engraving of the present invention preferably comprises Component B-1 as the main component of Component B, and when it comprises (Component B-2) another crosslinking agent, which is described later, the content of Component B-1 is preferably at least 60 mass % of the entire Component B, more preferably at least 70 mass %, and yet more preferably at least 80 mass %. The upper limit is not particularly restricted, but is preferably 100 mass %, that is, the resin composition comprises only Component B-1 as Component B. When it comprises another crosslinking agent, the content of Component B-1 is preferably no greater than 99 mass % of the entire Component B, more preferably no greater than 97 mass %, and yet more preferably no greater than 95 mass %.

In the present invention, the proportion of the total amount of Component A-1 and Component B-1 in the resin composition for laser engraving is preferably 60 to 100 mass % of the total solids content, and more preferably 80 to 99 mass %. It is preferable for the total content of Component A-1 and Component B-1 to be in this range since the generation of engraving residue in particular is suppressed.

### (Component B-2) Other Crosslinking Agent

The resin composition for laser engraving of the present invention may comprise (Component B-2) another crosslinking agent in addition to Component B-1. Said other crosslinking agent referred to here is a (non-depolymerizable) crosslinking agent, which is not depolymerizable.

Said other crosslinking agent is not particularly limited as long as it can form crosslinking, and a known agent may be used. Specific preferred examples include an ethylenically unsaturated compound, a silane compound, a polycarboxylic acid compound, a polycarboxylic acid halide compound, a polyol compound, a polyamine compound, a polyisocyanate compound, an acid anhydride compound, and a hydroxycarboxylic acid compound.

The silane compound as said other crosslinking agent is preferably a compound having at least one type from a hydrolyzable silyl group and a silanol group, which are described later.

Furthermore, the ethylenically unsaturated compound as said other crosslinking agent is preferably a polyfunctional ethylenically unsaturated compound.

Among them, said other crosslinking agent is preferably an ethylenically unsaturated compound and/or a compound comprising at least one type from a hydrolyzable silyl group and a silanol group, more preferably an ethylenically unsaturated compound and a compound comprising at least one type from a hydrolyzable silyl group and a silanol group, and yet more preferably a (meth)acrylate derivative and a compound comprising at least one type from a hydrolyzable silyl group and a silanol group. In this embodiment, it is possible to obtain a flexographic printing plate having excellent printing durability and swelling inhibition properties against aqueous ink and solvent ink.

Examples of the ethylenically unsaturated compound, silane compound, polycarboxylic acid compound, polycarboxylic acid halide compound, polyol compound, polyamine compound, polyisocyanate compound, acid anhydride compound, and hydroxycarboxylic acid compound that can be used in the other crosslinking agent include the step-growth polymerizable monomers and chain-growth polymerizable monomers described for Component A.

Among them, as the ethylenically unsaturated compound and the silane compound, the compounds below are preferable.

Furthermore, the polymerizable compound that can be used in the present invention preferably has a molecular weight (or weight-average molecular weight) of less than 5,000.

The ethylenically unsaturated compound is a compound having one or more ethylenically unsaturated groups. Regarding the ethylenically unsaturated compound, one kind may be used alone, or two or more kinds may be used in combination.

Furthermore, the compound group which belongs to ethylenically unsaturated compounds is widely known in the pertinent industrial fields, and in the present invention, these compounds can be used without particular limitations. These compounds have chemical forms such as, for example, monomer, prepolymer (namely, dimer, trimer and oligomer), or copolymer thereof, and mixture thereof.

As the ethylenically unsaturated compound, a polyfunctional monomer is preferably used. Molecular weights of these polyfunctional monomers are preferably 200 to 2,000.

As the polyfunctional ethylenically unsaturated compound, a compound having 2 to 20 terminal ethylenically unsaturated groups is preferable.

Examples of a compound from which the ethylenically unsaturated group in the polyfunctional ethylenically unsaturated compound is derived include unsaturated carboxylic acids (such as acrylic acid, methacrylic acid, itaconic acid, crotonic acid, isocrotonic acid and maleic acid), and esters and amides thereof. Preferably esters of an unsaturated carboxylic acid and an aliphatic polyhydric alcoholic compound, or amides of an unsaturated carboxylic acid and an aliphatic polyvalent amine compound are used. Moreover, addition reaction products of unsaturated carboxylic acid esters or amides having a nucleophilic substituent such as a hydroxyl group or an amino group with polyfunctional isocyanates or epoxies, and dehydrating condensation reaction products with a polyfunctional carboxylic acid, etc. are also used favorably. Moreover, addition reaction products of unsaturated carboxylic acid esters or amides having an electrophilic substituent such as an isocyanato group or an epoxy group with monofunctional or polyfunctional alcohols or amines, and substitution reaction products of unsaturated carboxylic acid esters or amides having a leaving group such as a halogen group or a tosyloxy group with monofunctional or polyfunctional alcohols or amines are also favorable. Moreover, as another example, the use of compounds obtained by replacing the unsaturated carboxylic acid with a vinyl compound, an allyl compound, an unsaturated phosphonic acid, styrene or the like is also possible.

The ethylenically unsaturated group which is comprised in the polyfunctional ethylenically unsaturated compound described above is preferably an residue of an acrylate compound, a methacrylate compound, a vinyl compound, or an aryl compound, and particularly preferably an acrylate compound or a methacrylate compound, from the viewpoint of reactivity. From the viewpoint of printing durability, the polyfunctional ethylenically unsaturated compound more preferably has three or more ethylenically unsaturated groups.

Specific examples of ester monomers comprising an ester of an aliphatic polyhydric alcohol compound and an unsaturated carboxylic acid include acrylic acid esters such as ethylene glycol diacrylate, triethylene glycol diacrylate, polyethylene glycol diacrylate, 1,3-butanediol diacrylate, tetramethylene glycol diacrylate, propylene glycol diacrylate, neopentyl glycol diacrylate, trimethylolpropane triacrylate, trimethylolpropane tri(acryloyloxypropyl)ether, trimethylolethane triacrylate, hexanediol diacrylate, 1,4-cyclohexanediol diacrylate, tetraethylene glycol diacrylate, pentaerythritol diacrylate, pentaerythritol triacrylate, pentaerythritol tetraacrylate, dipentaerythritol diacrylate, dipentaerythritol hexaacrylate, sorbitol triacrylate, sorbitol tetraacrylate, sorbitol pentaacrylate, sorbitol hexaacrylate, tri(acryloyloxyethyl) isocyanurate, and a polyester acrylate oligomer.

Examples of methacrylic acid esters include tetramethylene glycol dimethacrylate, triethylene glycol dimethacrylate, polyethylene glycol dimethacrylate, neopentyl glycol dimethacrylate, trimethylolpropane trimethacrylate, trimethylolethane trimethacrylate, ethylene glycol dimethacrylate, 1,3-butanediol dimethacrylate, hexanediol dimethacrylate, pentaerythritol dimethacrylate, pentaerythritol trimethacrylate, pentaerythritol tetramethacrylate, dipentaerythritol dimethacrylate, dipentaerythritol hexamethacrylate, sorbitol trimethacrylate, sorbitol tetramethacrylate, bis[p-(3-methacryloxy-2-hydroxypropoxy)phenyl]dimethylmethane, and bis[p-(methacryloxyethoxy)phenyl]dimethylmethane. Among them, trimethylolpropane trimethacrylate and polyethylene glycol dimethacrylate are particularly preferable.

As examples of other esters, aliphatic alcohol-based esters described in JP-B-46-27926 (JP-B denotes a Japanese examined patent application publication), JP-B-51-47334 and JP-A-57-196231, those having an aromatic skeleton described in JP-A-59-5240, JP-A-59-5241, and JP-A-2-226149, those having an amino group described in JP-A-1-165613, etc. may also be used preferably.

The above-mentioned ester monomers may be used as a mixture.

Furthermore, specific examples of amide monomers including an amide of an aliphatic polyamine compound and an unsaturated carboxylic acid include methylenebisacrylamide, methylenebismethacrylamide, 1,6-hexamethylenebisacrylamide, 1,6-hexamethylenebismethacrylamide, diethylenetriaminetrisacrylamide, xylylenebisacrylamide, and xylylenebismethacrylamide.

Preferred examples of other amide-based monomers include those having a cyclohexylene structure described in JP-B-54-21726.

Furthermore, a urethane-based addition-polymerizable compound produced by an addition reaction of an isocyanate and a hydroxy group is also suitable, and specific examples thereof include a vinylurethane compound comprising two or more polymerizable vinyl groups per molecule in which a hydroxy group-containing vinyl monomer represented by Formula (i) below is added to a polyisocyanate compound having two or more isocyanate groups per molecule described in JP-B-48-41708.

CH₂═C(R)COOCH₂CH(R′)OH (i)

wherein R and R′ independently denote H or CH₃.

Furthermore, urethane acrylates described in JP-A-51-37193, JP-B-2-32293, and JP-B-2-16765, and urethane compounds having an ethylene oxide-based skeleton described in JP-B-58-49860, JP-B-56-17654, JP-B-62-39417, JP-B-62-39418 are also suitable.

Furthermore, by use of an addition-polymerizable compound having an amino structure in the molecule described in JP-A-63-277653, JP-A-63-260909, and JP-A-1-105238, a resin composition having very good curing speed can be obtained.

Other examples include polyester acrylates such as those described in JP-A-48-64183, JP-B-49-43191, and JP-B-52-30490, and polyfunctional acrylates and methacrylates such as epoxy acrylates formed by a reaction of an epoxy resin and (meth)acrylic acid. Examples also include specific unsaturated compounds described in JP-B-46-43946, JP-B-1-40337, and JP-B-1-40336, and vinylphosphonic acid-based compounds described in JP-A-2-25493. In some cases, perfluoroalkyl group-containing structures described in JP-A-61-22048 are suitably used. Moreover, those described as photocuring monomers or oligomers in the Journal of the Adhesion Society of Japan, Vol. 20, No. 7, pp. 300 to 308 (1984) may also be used.

Among them, the polyfunctional ethylenically unsaturated compound preferably comprises a (meth)acrylate derivative, more preferably an alkylenediol di(meth)acrylate, yet more preferably an alkylenediol di(meth)acrylate in which the alkylenediol has 4 to 12 carbons, and particularly preferably 1,6-hexanediol di(meth)acrylate. When in this mode, a flexographic printing plate having excellent printing durability and swelling inhibition properties for aqueous ink and solvent ink can be obtained.

Furthermore, the other crosslinking agant preferably comprises a compound comprising at least one type from a hydrolyzable silyl group and a silanol group, and more preferably an ethylenically unsaturated compound and a compound comprising at least one type from a hydrolyzable silyl group and a silanol group. When in this mode, a flexographic printing plate having excellent rinsing properties for engraving residue and having excellent printing durability and swelling inhibition properties for aqueous ink and solvent ink can be obtained.

The ‘hydrolyzable silyl group’ in the compound comprising at least one type from a hydrolyzable silyl group and a silanol group is a silyl group that can be hydrolyzed; examples of the hydrolyzable group include an alkoxy group, a mercapto group, a halogen atom, an amide group, an acetoxy group, an amino group, and an isopropenoxy group. A silyl group undergoes hydrolysis to become a silanol group, and a silanol group undergoes dehydration-condensation to form a siloxane bond. Such a hydrolyzable silyl group or silanol group is preferably one represented by Formula (B-1) below.

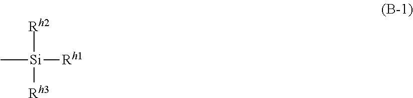

In Formula (B-1) above, at least one of R^{h1} to R^{h3} denotes a hydrolyzable group selected from the group consisting of an alkoxy group, a mercapto group, a halogen atom, an amide group, an acetoxy group, an amino group, and an isopropenoxy group, or a hydroxy group. The remainder of R^{h1} to R^{h3} independently denotes a hydrogen atom, a halogen atom, or a monovalent organic substituent (examples including an alkyl group, an aryl group, an alkenyl group, an alkynyl group, and an aralkyl group).

In Formula (B-1) above, the hydrolyzable group bonded to the silicon atom is particularly preferably an alkoxy group or a halogen atom, and more preferably an alkoxy group.

From the viewpoint of rinsing properties and printing durability, the alkoxy group is preferably an alkoxy group having 1 to 30 carbon atoms, more preferably an alkoxy group having 1 to 15 carbon atoms, yet more preferably an alkoxy group having 1 to 5 carbon atoms, particularly preferably an alkoxy group having 1 to 3 carbon atoms, and most preferably a methoxy group or an ethoxy group.

Furthermore, examples of the halogen atom include an F atom, a Cl atom, a Br atom, and an I atom, and from the viewpoint of ease of synthesis and stability it is preferably a Cl atom or a Br atom, and more preferably a Cl atom.

The compound comprising at least one type from a hydrolyzable silyl group and a silanol group in the present invention is preferably a compound having one or more groups represented by Formula (B-1) above, and more preferably a compound having two or more. A compound having two or more hydrolyzable silyl groups is particularly preferably used. That is, a compound having in the molecule two or more silicon atoms having a hydrolyzable group bonded thereto is preferably used. The number of silicon atoms having a hydrolyzable group bond thereto contained in Component E is preferably at least 1 but no greater than 6, and most preferably 1 or 2.

A range of 1 to 4 of the hydrolyzable groups may bond to one silicon atom, and the total number of hydrolyzable groups in Formula (B-1) is preferably in a range of 2 or 3. It is particularly preferable that three hydrolyzable groups are bonded to a silicon atom. When two or more hydrolyzable groups are bonded to a silicon atom, they may be identical to or different from each other.

Specific preferred examples of the alkoxy group include a methoxy group, an ethoxy group, a propoxy group, an isopropoxy group, a butoxy group, a tert-butoxy group, a phenoxy group, and a benzyloxy group. A plurality of each of these alkoxy groups may be used in combination, or a plurality of different alkoxy groups may be used in combination.

Examples of the alkoxysilyl group having an alkoxy group bonded thereto include a trialkoxysilyl group such as a trimethoxysilyl group, a triethoxysilyl group, a triisopropoxysilyl group, or a triphenoxysilyl group; a dialkoxymonoalkylsilyl group such as a dimethoxymethylsilyl group or a diethoxymethylsilyl group; and a monoalkoxydialkylsilyl group such as a methoxydimethylsilyl group or an ethoxydimethylsilyl group.

The compound comprising at least one type from a hydrolyzable silyl group and a silanol group preferably has at least a sulfur atom, an ester bond, a urethane bond, an ether bond, a urea bond, or an imino group.

Among them, from the viewpoint of crosslinkability, the compound comprising at least one type from a hydrolyzable silyl group and a silanol group preferably comprises a sulfur atom, and from the viewpoint of removability (rinsing properties) of engraving residue it is preferable for it to comprise an ester bond, a urethane bond, or an ether bond (in particular, an ether bond contained in an oxyalkylene group), which is easily decomposed by aqueous alkali. A compound comprising at least one type from a hydrolyzable silyl group and a silanol group containing a sulfur atom functions as a vulcanizing agent or a vulcanization accelerator when carrying out a vulcanization treatment, thus promoting a reaction (crosslinking) of a conjugated diene monomer unit-containing polymer. As a result, the rubber elasticity necessary as a printing plate is exhibited. Furthermore, the strength of a crosslinked relief-forming layer and a relief layer is improved.

Furthermore, the compound comprising at least one type from a hydrolyzable silyl group and a silanol group in the present invention is preferably a compound that does not have an ethylenically unsaturated bond.

As the compound comprising at least one type from a hydrolyzable silyl group and a silanol group in the present invention, there can be cited a compound in which a plurality of groups represented by Formula (B-1) above are bonded via a divalent linking group, and from the viewpoint of the effect, such a divalent linking group is preferably a linking group having a sulfide group (—S—), an imino group (—N(R)—) a urea group or a urethane bond (—OCON(R)— or —N(R)COO—). R denotes a hydrogen atom or a substituent. Examples of the substituent denoted by R include an alkyl group, an aryl group, an alkenyl group, an alkynyl group, and an aralkyl group.

A method for synthesizing the compound comprising at least one type from a hydrolyzable silyl group and a silanol group is not particularly limited, and synthesis can be carried out by a known method. Examples of the method include a method described in paragraphs 0019 to 0021 of JP-A-2011-136429.

The compound comprising at least one type from a hydrolyzable silyl group and a silanol group is preferably a compound represented by Formula (B-A-1) or Formula (B-A-2) below.

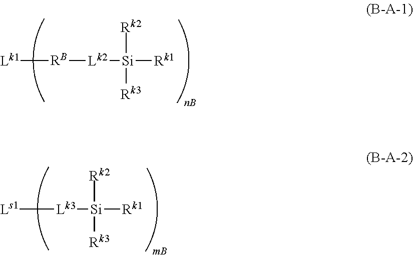

In Formula (B-A-1) and Formula (B-A-2), R^{B} denotes an ester bond, an amide bond, a urethane bond, a urea bond, or an imino group, L^{k1} denotes an n-valent linking group, L^{k2} denotes a divalent linking group, L^{s1} denotes an m-valent linking group, L^{k3} denotes a divalent linking group, nB and mB independently denote an integer of 1 or greater, and R^{k1} to R^{k3} independently denote a hydrogen atom, a halogen atom, or a monovalent organic substituent. In addition, at least one of R^{k1} to R^{k3} denotes a hydrolyzable group selected from the group consisting of an alkoxy group, a mercapto group, a halogen atom, an amide group, an acetoxy group, an amino group, and an isopropenoxy group, or a hydroxy group.

R^{k1} to R^{k3} in Formula (B-A-1) and Formula (B-A-2) above have the same meanings as those of R^{h1} to R^{h3} in Formula (B-1) above, and preferred ranges are also the same.

From the viewpoint of rinsing properties and film strength, R^{B} above is preferably an ester bond or a urethane bond, and is more preferably an ester bond.

The divalent or nB-valent linking group denoted by L^{k1} to L^{k3} above is preferably a group formed from at least one type of atom selected from the group consisting of a carbon atom, a hydrogen atom, an oxygen atom, a nitrogen atom, and a sulfur atom, and is more preferably a group formed from at least one type of atom selected from the group consisting of a carbon atom, a hydrogen atom, an oxygen atom, and a sulfur atom. The number of carbon atoms of L^{k1} to L^{k3} above is preferably 2 to 60, and more preferably 2 to 30.

The mB-valent linking group denoted by L^{s1} above is preferably a group formed from a sulfur atom and at least one type of atom selected from the group consisting of a carbon atom, a hydrogen atom, an oxygen atom, a nitrogen atom, and a sulfur atom, and is more preferably an alkylene group or a group formed by combining two or more from an alkylene group, a sulfide group, and an imino group. The number of carbon atoms of L^{s1} above is preferably 2 to 60, and more preferably 6 to 30.

nB and mB above are preferably and independently integers of 1 to 10, more preferably integers of 2 to 10, yet more preferably integers of 2 to 6, and particularly preferably 2.

From the viewpoint of removability (rinsing properties) of engraving residue, the nB-valent linking group denoted by L^{k1} and/or the divalent linking group denoted by L^{k2}, or the divalent linking group denoted by L^{k3} preferably has an ether bond, and more preferably has an ether bond contained in an oxyalkylene group.

Among compounds represented by Formula (B-A-1) or Formula (B-A-2), from the viewpoint of crosslinkability, etc., the nB-valent linking group denoted by L^{k1} and/or the divalent linking group denoted by L^{k2} in Formula (B-A-1) are preferably groups having a sulfur atom.

The compound comprising at least one type from a hydrolyzable silyl group and a silanol group is preferably a compound having at least an alkoxy group on the silicon atom of a silyl group, more preferably a compound having two alkoxy groups on the silicon atom of a silyl group, and yet more preferably a compound having three alkoxy group on the silicon atom of a silyl group.

Furthermore, specific examples of the compound comprising at least one type from a hydrolyzable silyl group and a silanol group include compounds described in paragraphs 0025 to 0037 of JP-A-2011-136429.

Among them, the compound comprising at least one type from a hydrolyzable silyl group and a silanol group is preferably a compound having a mercapto group or a sulfide bond, and particularly preferably a compound having a sulfide bond.

Furthermore, the total number of hydrolyzable silyl groups and silanol groups in the compound comprising at least one type from a hydrolyzable silyl group and a silanol group is preferably 1 to 6, more preferably 1 or 2, and particularly preferably 2.

### (Component C) Photothermal Conversion Agent

The resin composition for laser engraving of the present invention preferably further includes (Component C) a photothermal conversion agent. That is, it is considered that the photothermal conversion agent in the present invention can promote the thermal decomposition of a cured material during laser engraving by absorbing laser light and generating heat. Therefore, it is preferable that a photothermal conversion agent capable of absorbing light having a wavelength of laser used for graving be selected.

When a laser (a YAG laser, a semiconductor laser, a fiber laser, a surface emitting laser, etc.) emitting infrared at a wavelength of 700 to 1,300 nm is used as a light source for laser engraving, it is preferable for the flexographic printing plate precursor for laser engraving which is produced by using the resin composition for laser engraving of the present invention to comprise a photothermal conversion agent that has a maximun absorption wavelength at 700 to 1,300 nm.

As the photothermal conversion agent in the present invention, various types of dye or pigment are used.

With regard to the photothermal conversion agent, examples of dyes that can be used include commercial dyes and known dyes described in publications such as ‘Senryo Binran’ (Dye Handbook) (Ed. by The Society of Synthetic Organic Chemistry, Japan, 1970). Specific examples include dyes having a maximum absorption wavelength at 700 to 1,300 nm, and preferable examples include azo dyes, metal complex salt azo dyes, pyrazolone azo dyes, naphthoquinone dyes, anthraquinone dyes, phthalocyanine dyes, carbonium dyes, diimmonium compounds, quinone imine dyes, methine dyes, cyanine dyes, squarylium colorants, pyrylium salts, and metal thiolate complexes. In particular, cyanine-based colorants such as heptamethine cyanine colorants, oxonol-based colorants such as pentamethine oxonol colorants, and phthalocyanine-based colorants are preferably used. Examples include dyes described in paragraphs 0124 to 0137 of JP-A-2008-63554.

With regard to the photothermal conversion agent used in the present invention, examples of pigments include commercial pigments and pigments described in the Color Index (C.I.) Handbook, ‘Saishin Ganryo Binran’ (Latest Pigments Handbook) (Ed. by Nippon Ganryo Gijutsu Kyokai, 1977), ‘Saishin Ganryo Ouyogijutsu’ (Latest Applications of Pigment Technology) (CMC Publishing, 1986), ‘Insatsu Inki Gijutsu’ (Printing Ink Technology) (CMC Publishing, 1984). Examples of pigments include pigments described in paragraphs 0122 to 0125 of JP-A-2009-178869.

Among these pigments, carbon black is preferable.

Any carbon black, regardless of classification by ASTM (American Society for Testing and Materials) and application (e.g. for coloring, for rubber, for dry cell, etc.), may be used as long as dispersibility, etc. in the resin composition for laser engraving is stable. Examples of the carbon black include furnace black, thermal black, channel black, lamp black, and acetylene black. In order to make dispersion easy, a black colorant such as carbon black may be used as color chips or a color paste by dispersing it in nitrocellulose or a binder in advance using, as necessary, a dispersant, and such chips and paste are readily available as commercial products. Examples of carbon black include carbon blacks described in paragraphs 0130 to 0134 of JP-A-2009-178869.

The photothermal conversion agent preferably comprises a group that can form a covalent bond with Component A and/or Component B, and it is preferable for the surface of the photothermal conversion agent to comprise a group that can form a covalent bond with Component A and/or Component B. It is surmised that when the photothermal conversion agent comprises said group, the photothermal conversion agent behaves as a kind of crosslinking point between Component A molecules, between Component B molecules, or between Component A and Component B. In this case, it is surmised that due to the photothermal conversion agent functioning as a site to trigger depolymerization, higher engraving sensitivity can be obtained, the generation of engraving residue is further suppressed and, furthermore, rinsing properties for engraving residue that has been generated are better.

Preferred examples of combinations that can form a covalent bond include (isocyanate group/hydroxy group or amino group), (ethylenically unsaturated bond/ethylenically unsaturated bond), (hydroxy group/carboxy group), and (epoxy group/hydroxy group), but the present invention should not be construed as being limited thereto.

Among them, from the viewpoint of ready availability, the photothermal conversion agent is preferably one comprising a hydroxy group (OH group) and/or a carboxy group (COON group) on the surface.

In the present invention, the hydroxy group, the carboxy group, or the sum of the two functional groups that the photothermal conversion agent has on the surface is preferably at least 0.001 meq/g, more preferably 0.005 to 10.0 meq/g, more preferably 0.010 to 7.0 meq/g, and yet more preferably 0.020 to 5 meq/g. The content of these functional groups may be measured by the Boehm titration method described in paragraphs 0016 and 0017 of JP-A-2012-196900.

As a method for introducing a photothermal conversion agent group that can form a covalent bond with Component A and/or Component B, Japanese registered patent No. 5057261, Japanese registered patent No. 4692740, Japanese registered patent No. 4826886, Japanese registered patent No. 5093733, Japanese registered patent No. 5057265, etc. may be referred to.

The photothermal conversion agent comprising on the surface a group that can be shared with Component A and/or Component B may be a commercially available product, and specific examples thereof include a cyanine dye (e.g. ADS820HO) that is an infrared absorbing agent, made by American Dye Source, Inc.

With regard to the photothermal conversion agent in the resin composition of the present invention, one type thereof may be used or two or more types may be used in combination.

The content of the photothermal conversion agent in the resin composition for laser engraving depends greatly on the molecular extinction coefficient, which is unique to the molecule, but is preferably in the range of 0.01 to 30 mass % of the total solids content by mass of the resin composition, more preferably 0.05 to 20 mass %, and particularly preferably 0.1 to 10 mass %.

Furthermore, when the photothermal conversion agent comprises a group that can form a covalent bond with Component A and/or Component B, the content of the photothermal conversion agent in the resin composition for laser engraving is preferably no greater than 30 mass % of the total solids content by mass of the resin composition, more preferably 0.1 to 25 mass %, yet more preferably 0.5 to 20 mass %, and particularly preferably 1.0 to 10 mass %.

When the photothermal conversion agent comprises a group that can form a covalent bond with Component A and/or Component B, the photothermal conversion agent behaves as a site that converts light into heat and as a crosslinking site that triggers depolymerization, and sufficient engraving is possible with a smaller amount of photothermal conversion agent than a conventional amount.

### (Component D) Crosslinking Catalyst

The resin composition for laser engraving of the present invention preferably comprises (Component D) a crosslinking catalyst. It is preferable for it to comprise Component D since the formation of crosslinking by Component B is promoted. In the present invention, the crosslinking catalyst referred to here is not particularly limited as long as it is a compound that promotes the formation of crosslinking by a crosslinking agent and may be not only a so-called catalyst, which is unchanged after a reaction, but also one that undergoes a change in chemical structure between that before and that after a reaction, as with a polymerization initiator.

When an ethylenically unsaturated compound is used as the crosslinking agent, Component D preferably comprises a polymerization initiator. The polymerization initiator is preferably a radical polymerization initiator. It may be either a photopolymerization initiator or a thermopolymerization initiator, but is preferably a thermopolymerization initiator.

Furthermore, when a compound comprising a hydroxy group and a carboxy group is used as the crosslinking agent, Component D preferably comprises a polycondensation catalyst.

Moreover, when a silane compound, in particular a compound comprising at least one type from a hydrolyzable silyl group and a silanol group, is used as the crosslinking agent, Component D preferably comprises a silane coupling catalyst.

### <Polymerization Initiator>

In the present invention, preferable radical polymerization initiators include (a) aromatic ketones, (b) onium salt compounds, (c) organic peroxides, (d) thio compounds, (e) hexaallylbiimidazole compounds, (f) ketoxime ester compounds, (g) borate compounds, (h) azinium compounds, (i) metallocene compounds, (j) active ester compounds, (k) compounds having a carbon halogen bond, and (l) azo compounds. Hereinafter, although specific examples of the (a) to (l) are cited, the present invention is not limited to these.

In the present invention, when applies to the relief-forming layer of the flexographic printing plate precursor, from the viewpoint of engraving sensitivity and making a favorable relief edge shape, (c) organic peroxides and (l) azo compounds are more preferable, and (c) organic peroxides are particularly preferable.

The (a) aromatic ketones, (b) onium salt compounds, (d) thio compounds, (e) hexaallylbiimidazole compounds, (f) ketoxime ester compounds, (g) borate compounds, (h) azinium compounds, (i) metallocene compounds, (j) active ester compounds, and (k) compounds having a carbon halogen bonding may preferably include compounds described in paragraphs 0074 to 0118 of JP-A-2008-63554.

Moreover, (c) organic peroxides and (l) azo compounds preferably include the following compounds.

### (c) Organic Peroxide

Preferred examples of the organic peroxide (c) as a polymerization initiator that can be used in the present invention include peroxyester-based ones such as 3,3′,4,4′-tetra(t-butylperoxycarbonyl)benzophenone, 3,3′,4,4′-tetra(t-amylperoxycarbonyl)benzophenone, 3,3′,4,4′-tetra(t-hexylperoxycarbonyl)benzophenone, 3,3′,4,4′-tetra(t-octylperoxycarbonyl)benzophenone, 3,3′,4,4′-tetra(cumylperoxycarbonyl)benzophenone, 3,3′,4,4′-tetra(p-isopropylcumylperoxycarbonyl)benzophenone, t-butylperoxybenzoate, di-t-butyldiperoxyisophthalate, t-butylperoxy-3-methylbenzoate, t-butylperoxylaurate, t-butylperoxypivalate, t-butylperoxy-2-ethylhexanoate, t-butylperoxy-3,5,5-trimethylhexanoate, t-butylperoxyneoheptanoate, t-butylperoxyneodecanoate, and t-butylperoxyacetate, α,α′-di(t-butylperoxy)diisopropylbenzene, t-butylcumylperoxide, di-t-butylperoxide, t-butylperoxyisopropylmonocarbonate, and t-butylperoxy-2-ethylhexylmonocarbonate.

### (I) Azo Compounds

Preferable (I) azo compounds as a polymerization initiator that can be used in the present invention include those such as 2,2′-azobisisobutyronitrile, 2,2′-azobispropionitrile, 1,1′-azobis(cyclohexane-1-carbonitrile), 2,2′-azobis(2-methylbutyronitrile), 2,2′-azobis(2,4-dimethylvaleronitrile), 2,2′-azobis(4-methoxy-2,4-dimethylvaleronitrile), 4,4′-azobis(4-cyanovaleric acid), dimethyl 2,2′-azobis(isobutyrate), 2,2′-azobis(2-methylpropionamideoxime), 2,2′-azobis[2-(2-imidazolin-2-yl)propane], 2,2′-azobis{2-methyl-N-[1,1-bis(hydroxymethyl)-2-hydroxyethyl]propionamide}, 2,2′-azobis[2-methyl-N-(2-hydroxyethyl)propionamide], 2,2′-azobis(N-butyl-2-methylpropionamide), 2,2′-azobis(N-cyclohexyl-2-methylpropionamide), 2,2′-azobis[N-(2-propenyl)-2-methyl-propionamide], 2,2′-azobis(2,4,4-trimethylpentane).

In the present invention, the organic peroxide (c) is particularly preferable as the polymerization initiator in the present invention from the viewpoint of crosslinking properties of the film (relief-forming layer) and improving the engraving sensitivity.

From the viewpoint of the engraving sensitivity, an embodiment obtained by combining (c) an organic peroxide, crosslinking agent having an ethylenically unsaturated group and a photothermal conversion agent is particularly preferable.

This is presumed as follows. When the relief-forming layer is cured by thermal crosslinking using an organic peroxide, an organic peroxide that did not play a part in radical generation and has not reacted remains, and the remaining organic peroxide works as an autoreactive additive and decomposes exothermally in laser engraving. As the result, energy of generated heat is added to the irradiated laser energy to thus raise the engraving sensitivity.

It will be described in detail in the explanation of photothermal converting agent, the effect thereof is remarkable when carbon black is used as the photothermal converting agent. It is considered that the heat generated from the carbon black is also transmitted to (c) an organic peroxide and, as the result, heat is generated not only from the carbon black but also from the organic peroxide, and that the generation of heat energy to be used for the decomposition of Component A etc. occurs synergistically.

### <Polycondensation Catalyst>

When the laser engraving resin composition of the present invention comprises a compound comprising a hydroxy group and a carboxy group as the crosslinking agent, it preferably comprises a polycondensation catalyst in order to promote an esterification reaction and/or an ester exchange reaction.

A generally used polycondensation catalyst may be used without any particular limitations.

Examples of the polycondensation catalyst include dibutyltin oxide, monobutyltin-2-ethyl hexanoate, dibutyltin dilaurate, tin acetate, zinc acetate, lead acetate, lead naphthenate, tetrabutyl titanate, tetraisopropyl titanate, sodium hydroxide, potassium hydroxide, sodium acetate, lithium acetate, and lithium hydroxide, which are usually used in an esterification reaction and an ester exchange reaction. With regard to these polycondensation catalysts, only one type thereof may be used or two or more types may be used in combination.

### <Silane Coupling Catalyst>

In the case of using a silane compound as other crosslinking agent in the resin composition for laser engraving of the present invention, it is preferable to further comprise a silane coupling catalyst in order to accelerate the reaction with a silane compound.

As the silane coupling catalyst, any reaction catalyst that is generally used can be applied without limitation. The silane coupling catalyst may be used as a polycondensation catalyst.

Hereinafter, an acidic or a basic catalyst, and metal complex catalysts, which are representative silane coupling catalysts, will be described in sequence.

### Acidic or Basic Catalyst

As the silane coupling catalyst, an acidic or a basic compound is used as it is or in the form of a solution in which it is dissolved in a solvent such as water or an organic solvent (hereinafter, called an acidic catalyst or a basic catalyst). The concentration when dissolved in a solvent is not particularly limited, and it may be selected appropriately according to the properties of the acidic or basic compound used, desired catalyst content, etc.

The type of the acidic or basic catalyst is not limited, and examples of the acidic catalyst include halogenated hydrogen such as hydrochloric acid, nitric acid, sulfuric acid, sulfurous acid, hydrogen sulfide, perchloric acid, hydrogen peroxide, carbonic acid, carboxylic acids such as formic acid and acetic acid, substituted carboxylic acids in which R of a structural formula represented by RCOOH is substituted by another element or substituent, sulfonic acids such as benzenesulfonic acid, phosphoric acid, etc, and examples of the basic catalyst include an ammoniacal base such as aqueous ammonia, an amine such as ethyl amine and aniline etc. Among these, from the viewpoint of progressing fastly a condensation reaction of silane compounds in the layer, methanesulfonic acid, p-toluenesulfonic acid, pyridinium-p-toluene sulfonate, phosphoric acid, phosphonic acid, acetic acid, 1,8-diazabicyclo[5.4.0]undec-7-ene, and hexamethylenetetramine are preferable, methanesulfonic acid, p-toluenesulfonic acid, phosphoric acid, 1,8-diazabicyclo[5.4.0]undec-7-ene, and hexamethylenetetramineare are more preferable, and 1,8-diazabicyclo[5.4.0]undec-7-ene phosphoric acid and are particularly preferable.

### Metal Complex Catalyst

The metal complex catalyst that can be used as a silane coupling exchange reaction catalyst in the present invention is preferably constituted from a metal element selected from Groups 2, 4, 5, and 13 of the periodic table and an oxo or hydroxy oxygen compound selected from β-diketones (acetylacetone is preferable), ketoesters, hydroxycarboxylic acids and esters thereof, amino alcohols, and enolic active hydrogen compounds.

Furthermore, among the constituent metal elements, a Group 2 element such as Mg, Ca, Sr, or Ba, a Group 4 element such as Ti or Zr, a Group 5 element such as V, Nb, or Ta, and a Group 13 element such as Al or Ga are preferable, and they form a complex having an excellent catalytic effect. Among them, a complex obtained from Zr, Al, or Ti is excellent and preferable, and more preferred examples of the metal complex catalyst include ethyl orthotitanate, etc.

These metal complex catalysts are excellent in terms of stability in an aqueous coating solution and an effect in promoting gelling in a sol-gel reaction when thermally drying, and among them, ethyl acetoacetate aluminum diisopropylate, aluminum tris(ethyl acetoacetate), a di(acetylacetonato)titanium complex salt, and zirconium tris(ethyl acetoacetate) are particularly preferable.

Component D in the resin composition of the present invention may be used singly or in a combination of two or more compounds.

The content of Component D in the resin composition of the present invention is preferably 0.1 to 20 mass % relative to the total mass of the solids content, more preferably 0.3 to 10 mass %, and particularly preferably 0.5 to 5 mass %. It is preferable for the content of Component D to be in the above-mentioned range since rinsing properties and ink transfer properties are excellent.

(Component E) Depolymerization Catalyst and/or Depolymerization Catalyst Precursor

In the present invention, a depolymerization catalyst and/or a depolymerization catalyst precursor may be contained. Specifically, they can be classified into acid-generating compounds (acid generators), base-generating compounds (base generators), radical-generating compounds (radical generators), and metal compounds. When Component A or Component B is an addition polymer, it is preferable for an acid generator, a base generator, or a radical generator to be contained, and when it is a polycondensation resin such as a polyester, it is preferable for a metal compound to be contained. When Component A or Component B is a polycondensation resin such as a polyester, a metal compound that is used as a polycondensation catalyst also functions as a depolymerization catalyst.

### <Compound Capable of Generating Acid>

The acid generator used in the present invention is a compound which generates an acid by the effect of light or heat, and examples thereof include the compounds described in JP-A-10-282644 (paragraphs 0039 to 0063).

Specific examples thereof include onium salts such as diazonium salts described in S. I. Schlesinger, Photogr. Sci. Eng., 18, 387 (1974), T. S. Bal et al., Polymer, 21, 423 (1980), etc., ammonium salts described in U.S. Pat. Nos. 4,069,055 and 4,069,056, JP-A-3-140140, etc., phosphonium salts described in D. C. Necker et al., Macromolecules, 17, 2468 (1984), C. S. Wen et al., Teh, Proc. Conf. Rad. Curing ASIA, page 478, Tokyo, October (1988), U.S. Pat. Nos. 4,069,055 and 4,069,056, etc., iodonium salts described in J. V. Crivello et al., Macromolecules, 10 (6) 1307 (1977), Chem. & Eng. News, November 28, page 31 (1988), European Patent 104,143, U.S. Pat. Nos. 339,049 and 410,201, JP-A-2-150848, JP-A-2-296514, etc., sulfonium salts described in J. V. Crivello et al., Polymer J., 17, 73 (1985), J. V. Crivello et al., J. Org. Chem., 43, 3055 (1978), W. R. Watt et al., J. Polymer Sci., Polymer Chem. Ed., 22, 1789 (1984), J. V. Crivello et al., Polymer Bull., 14, 279 (1985), J. V. Crivello et al., Macromolecules, 14 (5), 1141 (1981), J. V. Crivello et al., J. Polymer Sci., Polymer Chem. Ed., 17, 2877 (1979), European Patent 370,693, U.S. Pat. No. 3,902,114, European Patents 233,567, 297,443 and 297,442, U.S. Pat. Nos. 4,933,377, 410, 201, 339,049, 4,760,013, 4,734,444 and 2,833,827, German Patents 2,904,626, 3,604,580 and 3,604,581, etc., selenonium salts described in J. V. Crivello et al., Macromolecules, 10 (6), 1307 (1977), J. V. Crivello et al., J. Polymer Sci., Polymer Chem. Ed., 17, 1047 (1979), etc., and arsonium salts described in C. S. Wen et al., Teh, Proc. Conf. Rad. Curing ASIA, page 478, Tokyo, October (1988), etc.; organohalogen compounds described in U.S. Pat. No. 3,905,815, JP-B-46-4605 (the term “JP-B” as used herein means an “examined Japanese patent publication”), JP-A-48-36281, JP-A-55-32070, JP-A-60-239736, JP-A-61-169835, JP-A-61-169837, JP-A-62-58241, JP-A-62-212401, JP-A-63-70243, JP-A-63-298339, etc.; organic metals/organic halides described in K. Meier et al., J. Rad. Curing, 13 (4), 26 (1986), T. P. Gill et al., lnorg. Chem., 19, 3007 (1980), D. Astruc, Acc. Chem. Res., 19 (12), 377 (1896), JP-A-2-161445, etc.; photoacid generators having an o-nitrobenzyl type protective group described in S. Hayase et al., J. Polymer Sci., 25, 753 (1987), E. Reichmanis et al., J. Polymer Sci., Polymer Chem. Ed., 23, 1 (1985), Q. Q. Zhu et al., J. Photochem., 36, 85, 39, 317 (1987), B. Amit et al., Tetrahedron Lett., (24) 2205 (1973), D. H. R. Barton et al., J. Chem. Soc., 3571 (1965), P. M. Collins et al., J. Chem. Soc., Perkin 1,1695 (1975), M. Rudinstein et al., Tetrahedron Lett., (17), 1445 (1975), J. W. Walker et al., J. Am. Chem. Soc., 110, 7170 (1988), S. C. Busman et al., J. Imaging Technol, 11 (4), 191 (1985), H. M. Houlihan et al., Macromolecules, 21, 2001 (1988), P. M. Collins et al., J. Chem. Soc., Chem. Commun., 532 (1972), S. Hayase et al., Macromolecules, 18, 1799 (1985), E. Reichmanis et al., J. Electrochem. Soc., Solid State Sci. Technol., 130 (6), F. M. Houlihan et al., Macromolecules, 21, 2001 (1988), European Patents 0,290,750, 046, 083, 156, 535, 271,851 and 0,388,343, U.S. Pat. Nos. 3,901,710 and 4,181,531, JP-A-60-198538, JP-A-53-133022, etc.; compounds capable of generating a sulfonic acid resulting from decomposition, as represented by iminosulfonate and the like, described in M. TUNOOKA et al., Polymer Preprints Japan, 35 (8), G. Berner et al., J. Rad. Curing, 13 (4), W. J. Mijs et al., Coating Technol., 55 (697), 45 (1983), Akzo, H. Adachi et al., Polymer Preprints, Japan, 37 (3), European Patents 0,199,672, 84,515, 199, 672, 044,115 and 0,101,122, U.S. Pat. Nos. 4,618,564, 4,371,605 and 4,431,774, JP-A-64-18143, JP-A-2-245756, JP-A-4-365048, etc.; disulfone compounds described in JP-A-61-166544, etc.; o-naphthoquinonediazide-4-sulfonic acid halides described in JP-A-50-36209 (corresponding to U.S. Pat. No. 3,969,118); and o-naphthoquinonediazide compounds described in JP-A-55-62444 (corresponding to British Patent 2,038,801) and JP-B-1-11935.

Of these acid generators, particularly effective compounds are described below.

(1) Iodonium salt represented by the following formula (PAG3), and sulfonium salt or diasonium salt represented by formula (PAG4):

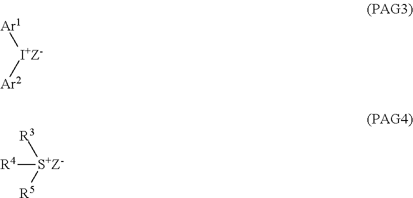

In these formulae, Ar¹ and Ar² each independently represents a substituted or unsubstituted aryl group. Preferred examples of the substituent include an alkyl group, a haloalkyl group, a cycloalkyl group, an aryl group, an alkoxy group, a nitro group, a carboxyl group, an alkoxycarbonyl group, a hydroxy group, a mercapto group and a halogen atom.

R³, R⁴ and R⁵ each independently represents a substituted or unsubstituted alkyl or aryl group, preferably an aryl group having a carbon number of 6 to 14, an alkyl group having a carbon number of 1 to 8, or a substitution derivative thereof. Preferred examples of the substituent for the aryl group include an alkoxy group having a carbon number of 1 to 8, an alkyl group having a carbon number of 1 to 8, a nitro group, a carboxyl group, a hydroxy group and a halogen atom, and preferred examples of the substituent for the alkyl group include an alkoxy group having a carbon number of 1 to 8, a carboxyl group and an alkoxycarbonyl group. Two members out of R³, R⁴ and R⁵, or Ar¹ and Ar² may combine through a single bond or a substituent

Z⁻ represents a counter anion, and examples thereof include, but are not limited to, BF₄⁻, AsF₆⁻, PF₆⁻, SbF₆⁻, SiF₆²⁻, ClO₄⁻, perfluoroalkanesulfonate anion (e.g., CF₃SO₃⁻, C₄F₉SO₃⁻), pentafluorobenzenesulfonate anion, bonded polynuclear aromatic sulfonate anion (e.g., naphthalene-1-sulfonate anion), anthraquinonesulfonate anion and sulfonic acid group-containing dye.

Specific examples of these onium salts include, but are not limited to, the following compounds.

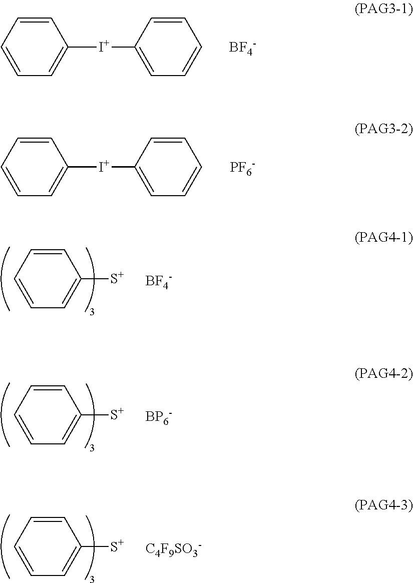

The above-described onium salts represented by formulae (PAG3) and (PAG4) are known and can be synthesized by the method described, for example, in J. W. Knapczyk et al., J. Am. Chem. Soc., 91, 145 (1969), A. L. Maycok et al., J. Org. Chem., 35, 2532 (1970), B. Goethas et al., Bull. Soc. Chem. Belg., 73, 546 (1964), H. M. Leicester, J. Am. Chem. Soc., 51, 3587 (1929), J. V. Crivello et al., S. Polym. Chem. Ed., 18, 2677 (1980), U.S. Pat. Nos. 2,807,648 and 4,247,473, and JP-A-53-101331.

The amount of the acid generator used is preferably from 0.1 to 50 mass %, more preferably from 1 to 40 mass %, based on the entire solid content in the composition. Within this range, high sensitivity and good stability are obtained.

### <Compound Capable of Generating Base>

As for the base generator used in the invention, compounds described in JP-A-2-166450, page 6, from upper left column, line 2 to upper right column, line 15 may be preferably used. Specifically, a compound capable of causing some reaction when heated and resultantly releasing a base is preferred, and examples thereof include a salt of an organic acid with a base, which undergoes decarboxylation when heated, and a compound which releases amines as a result of a reaction such as intramolecular nucleophilic substitution reaction, Lossen rearrangement and Beckmann rearrangement.

Specifically, an acid salt of a base may be used. Examples of the base include guanidine, triphenylguanidine, tricyclohexylguanidine, piperidine, morpholine, p-toluidine and 2-picoline, and examples of the acid include acetic acid, trichloroacetic acid, phenylsulfonylacetic acid, 4-methylsulfonylphenylsulfonylacetic acid, 4-acetylamino-methylpropionic acid, oxalic acid, maleic acid, succinic acid, fumaric acid, carbonic acid and bicarbonic acid.

These base generators may be introduced so as to be dispersed as particles into a layer of a pattern-forming material, which is described later, or may be introduced in a state in which they are included in microcapsules, which are described later.

Specific examples of the base generator include, but are not limited to, the compounds shown below.

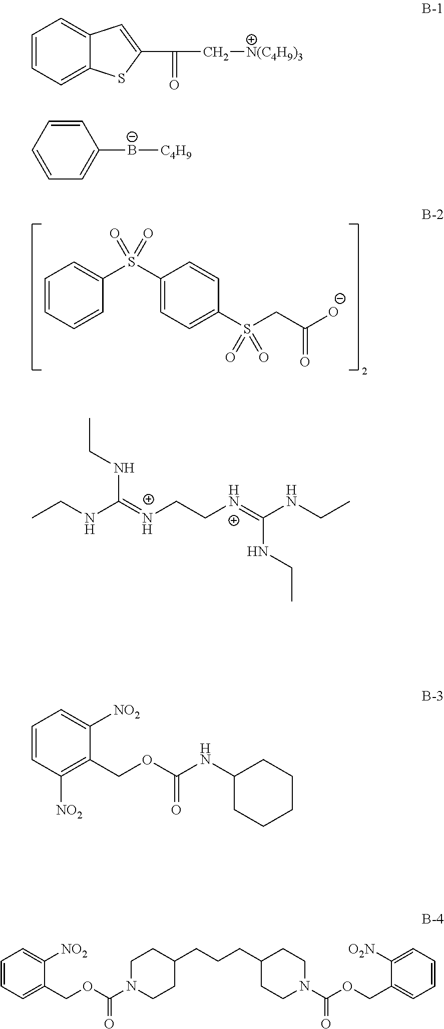

The amount of the base generator added is preferably from 0.1 to 50 mass %, more preferably from 1 to 40 mass %, based on the entire solid content in the composition. Within this range, high sensitivity and good stability are obtained.

### <Compound Capable of Generating Radical>

The radical generator for use in the present invention may be appropriately selected from known polymerization initiators or compounds having a bond with small bond dissociation energy. Two or more kinds of compounds capable of generating a radical may be used in combination.

The compound capable of generating a radial is described in JP-A-2004-306582. Examples of the compound capable of generating a radical include a halogenated organic compound, a carbonyl compound, an organic peroxide, an azo-based polymerization initiator, an azide compound, a metallocene compound, a hexaarylbiimidazole compound, an organoboric compound, a disulfonic compound, an oxime ester compound and an oxime salt compound. A hexaarylbiimidazole compound and an onium salt are most preferred.

The amount of the radical generator added is preferably from 0.1 to 50 mass %, more preferably from 1 to 40 mass %, based on the entire solid content in the composition. Within this range, high sensitivity and good stability are obtained.

### <Metal Compound>

The resin composition for laser engraving of the present invention may comprise a metal compound as the depolymerization catalyst or the depolymerization catalyst precursor, and it is preferable for it to comprise a metal compound containing a metal selected from the group consisting of Groups 1 to 15 of the periodic table.

Here, the ‘metal’ referred to in the present invention means one classified as a metal in the periodic table of the elements. Specifically, it means one classified as a metal in the periodic table as described in D. F. Shriver, P. W. Atkins, Inorganic Chemistry 3^{rd} Ed., OXFORD University Press, 1999, P. 283-, and examples thereof include an alkali metal such as sodium or potassium, an alkaline earth metal such as magnesium or calcium, a transition metal such as titanium, vanadium, molybdenum, manganese, iron, cobalt, nickel, copper, or zinc, and a typical metal such as aluminum, gallium, tin, lead, or bismuth.

With regard to the metal compound in the present invention, any compound may be used as long as it contains a metal selected from Groups 1 to 15 of the periodic table, but it does not include a metal element or an alloy. As the metal compound, specifically, a metal salt or a metal complex is preferably used.

The metal compound that is suitably used in the present invention is specifically explained below.

The metal compound in the present invention preferably comprises at least one metal selected from the group consisting of Groups 1, 2, 4, 12, 13, 14, and 15 of the periodic table from the viewpoint of engraving sensitivity.

In particular, from the viewpoint of engraving sensitivity and rinsing properties for engraving residue, a metal compound comprising at least one metal selected from the group consisting of Na, K, Ca, Mg, Ti, Zr, Al, Zn, Sn, and Bi is preferable.

Furthermore, an anion moiety of the metal compound in the present invention is not particularly limited; it may be selected appropriately according to the intended purpose, and is preferably, from the viewpoint of thermal stability, at least one type selected from the group consisting of oxide, sulfide, halide, carbonate, carboxylate, sulfonate, phosphate, nitrate, sulfate, alkoxide, hydroxide, and an optionally substituted acetylacetonate complex.

In particular, a metal compound comprising at least one type selected from the group consisting of halide, carboxylate, nitrate, sulfate, hydroxide, and an optionally substituted acetylacetonate complex is preferable.

More specifically, the metal compound in the present invention comprises at least one metal selected from the group consisting of Groups 1, 2, 4, 12, 13, 14, and 15 of the periodic table, and is preferably an oxide, sulfide, halide, carbonate, carboxylate, sulfonate, phosphate, nitrate, sulfate, alkoxide, hydroxide, or optionally substituted acetylacetonate complex of the metal.

In particular, a metal compound that comprises at least one metal selected from the group consisting of Na, K, Ca, Mg, Ti, Zr, Al, Zn, Sn, and Bi, and is an oxide, sulfide, halide, carbonate, carboxylate, sulfonate, phosphate, nitrate, sulfate, alkoxide, hydroxide, or optionally substituted acetylacetonate complex of the metal is preferable.

On the other hand, a metal compound that comprises at least one of metal selected from the group consisting of Group 1, 2, 4, 12, 13, 14, and 15 of the periodic table, and is a halide, carboxylate, nitrate, sulfate, hydroxide, or optionally substituted acetylacetonate complex of the metal is also preferable.

Among them, a metal compound that comprises at least one metal selected from the group consisting of Na, K, Ca, Mg, Ti, Zr, Al, Zn, Sn, and Bi, and is a halide, carboxylate, nitrate, sulfate, hydroxide, or optionally substituted acetylacetonate complex metal is particularly preferable.

The metal compound of the present invention is now shown by way of examples of combinations of metal and anion moiety.

Na: alkoxide, carboxylate, or optionally substituted acetylacetonate group

K: alkoxide, carboxylate, or optionally substituted acetylacetonate group

Ca: oxide, halide, carboxylate, nitrate, or optionally substituted acetylacetonate complex

Mg: oxide, halide, carboxylate, nitrate, or optionally substituted acetylacetonate complex

Ti: alkoxide, or optionally substituted acetylacetonate complex

Zr: alkoxide, or optionally substituted acetylacetonate complex

Al: chloride, alkoxide, hydroxide, carboxylate, or optionally substituted acetylacetonate complex

Zn: oxide, halide, carboxylate, or optionally substituted acetylacetonate complex

Sn: halide, carboxylate, or optionally substituted acetylacetonate complex

Bi: halide, carboxylate, or optionally substituted acetylacetonate complex

Specific examples of the metal compound in the present invention include sodium methoxide, sodium acetate, sodium 2-ethylhexanoate, (2,4-pentanedionato)sodium, potassium butoxide, potassium acetate, potassium 2-ethylhexanoate, (2,4-pentanedionato)potassium, calcium fluoride, calcium chloride, calcium bromide, calcium iodide, calcium oxide, calcium sulfide, calcium acetate, calcium 2-ethylhexanoate, calcium phosphate, calcium nitrate, calcium sulfate, calcium ethoxide, bis(2,4-pentanedionato)calcium, magnesium fluoride, magnesium chloride, magnesium bromide, magnesium iodide, magnesium oxide, magnesium sulfide, magnesium acetate, magnesium 2-ethylhexanoate, magnesium phosphate, magnesium nitrate, magnesium sulfate, magnesium ethoxide, bis(2,4-pentanedionato)magnesium, titanium ethoxide, bis(2,4-pentanedionato)titanium oxide, zirconium ethoxide, tetrakis(2,4-pentanedionato)zirconium, vanadium chloride, manganese oxide, bis(2,4-pentanedionato)manganese, iron chloride, tris(2,4-pentanedionato)iron, iron bromide, ruthenium chloride, cobalt chloride, rhodium chloride, iridium chloride, nickel chloride, bis(2,4-pentanedionato)nickel, palladium chloride, palladium acetate, bis(2,4-pentanedionato)palladium, platinum chloride, copper chloride, copper oxide, copper sulfate, bis(2,4-pentanedionato)copper, silver chloride, aluminum isopropoxide, hydroxyaluminum bis(acetate), hydroxyaluminum bis(2-ethylhexanoate), dihydroxyaluminum stearate, hydroxyaluminum bisstearate, aluminum trisstearate, tris(2,4-pentanedionato)aluminum, zinc chloride, zinc nitrate, zinc acetate, zinc benzoate, zinc oxide, zinc sulfide, bis(2,4-pentanedionato)zinc, 2-ethylhexane zinc, tin chloride, tin 2-ethylhexanoate, bis(2,4-pentanedionato)tin dichloride, lead chloride, bismuth 2-ethylhexanoate, and bismuth nitrate.

With regard to the metal compounds described above, the type of compound effective for improving engraving sensitivity depends on the type of binder polymer. Combinations of binder polymer type and preferred metal compound are given below.

With regard to a vinyl-based polymer, a metal compound comprising sodium, potassium, calcium, magnesium, nickel, aluminum, zinc, tin, or bismuth is preferable; among them an oxide, halide, carboxylate, nitrate, hydroxide, or optionally substituted acetylacetonate complex of the metal is more preferable, and sodium 2-ethylhexanoate, potassium 2-ethylhexanoate, calcium oxide, calcium chloride, bis(2,4-pentanedionato)calcium, bis(2,4-pentanedionato)magnesium, hydroxyaluminum bis(2-ethylhexanoate), zinc oxide, zinc chloride, zinc acetate, zinc nitrate, 2-ethylhexane zinc, tin chloride, or tin 2-ethylhexanoate is particularly preferable.

From the viewpoint of achieving a balance between engraving sensitivity and film formation, the content of the metal compound in the resin composition of the present invention is preferably 0.01 mass % to 50 mass % of Component A, more preferably 0.1 mass % to 40 mass %, and particularly preferably 0.1 mass % to 20 mass %.

Furthermore, from the viewpoint of achieving a balance between engraving sensitivity and film formation, the content of the metal compound in the resin composition of the present invention is preferably 0.01 mass % to 30 mass % of the entire resin composition, more preferably 0.1 mass % to 20 mass %, and particularly preferably 1 mass % to 10 mass %.

Various types of Components contained in the resin composition for laser engraving of the present invention other than Components A to E are explained below.

### <Plasticizer>

The resin composition for laser engraving of the present invention may comprise a plasticizer.

A plasticizer has the function of softening a film formed from the resin composition for laser engraving, and it is necessary for it to be compatible with a binder polymer.

Preferred examples of the plasticizer include dioctyl phthalate, didodecyl phthalate, bisbutoxyethyl adipate, a polyethylene glycol, and a polypropylene glycol (monool type or diol type).

Among them, bisbutoxyethyl adipate is particularly preferable.

With regard to the plasticizer in the resin composition of the present invention, one type thereof may be used on its own or two or more types may be used in combination.

### <Solvent>

It is preferably to use a solvent when preparing the resin composition for laser engraving of the present invention.

As the solvent, an organic solvent is preferably used.

Specific preferred examples of the aprotic organic solvent include acetonitrile, tetrahydrofuran, dioxane, toluene, propylene glycol monomethyl ether acetate, methyl ethyl ketone, acetone, methyl isobutyl ketone, ethyl acetate, butyl acetate, ethyl lactate, N,N-dimethylacetamide, N-methylpyrrolidone, and dimethyl sulfoxide.

Specific preferred examples of the protic organic solvent include methanol, ethanol, 1-propanol, 2-propanol, 1-butanol, 1-methoxy-2-propanol, ethylene glycol, diethylene glycol, and 1,3-propanediol.

Among these, propylene glycol monomethyl ether acetate is preferable.

### <Other Additives>

The resin composition for laser engraving of the present invention may comprise as appropriate various types of known additives as long as the effects of the present invention are not inhibited. Examples include a filler, a wax, a process oil, an a metal oxide, an antiozonant, an anti-aging agent, a thermopolymerization inhibitor, and a colorant, and one type thereof may be used on its own or two more types may be used in combination.

As the filler, inorganic particles can be cited, and silica particles can be preferably cited.

The inorganic particles preferably have a number-average particle size of at least 0.01 μm but no greater than 10 μm. Furthermore, the inorganic particles are preferably porous particles or nonporous particles.

The porous particles referred to here are defined as particles having fine pores having a pore volume of at least 0.1 mL/g in the particle or particles having fine cavities.

The porous particles preferably have a specific surface area of at least 10 m²/g but no greater than 1,500 m²/g, an average pore diameter of at least 1 nm but no greater than 1,000 nm, a pore volume of at least 0.1 mL/g but no greater than 10 mL/g, and an oil adsorption of at least 10 mL/100 g but no greater than 2,000 mL/100 g. The specific surface area is determined based on the BET equation from the adsorption isotherm of nitrogen at −196° C. Furthermore, measurement of the pore volume and the average pore diameter preferably employs a nitrogen adsorption method. Measurement of the oil adsorption may be suitably carried out in accordance with JIS-K5101.

The number-average particle size of the porous particles is preferably at least 0.01 μm but no greater than 10 μm, more preferably at least 0.5 μm but no greater than 8 μm, and yet more preferably at least 1 μm but no greater than 5 μm.

The shape of the porous particles is not particularly limited, and spherical, flat-shaped, needle-shaped, or amorphous particles, or particles having projections on the surface, etc. may be used.

Furthermore, particles having a cavity in the interior, spherical granules having a uniform pore diameter such as a silica sponge, etc. may be used. Examples thereof are not particularly limited but include porous silica, mesoporous silica, a silica-zirconia porous gel, porous alumina, and a porous glass. Furthermore, as for a layered clay compound, pore diameter cannot be defined for those having a cavity of a few nm to a few hundred nm between layers, and in the present embodiment the distance between cavities present between layers is defined as the pore diameter.

Moreover, particles obtained by subjecting the surface of porous particles to a surface modifying treatment by covering with a silane coupling agent, a titanium coupling agent, or another organic compound so as to make the surface hydrophilic or hydrophobic may also be used. With regard to these porous particles, one type or two or more types may be selected.

The nonporous particles are defined as particles having a pore volume of less than 0.1 mL/g. The number-average particle size of the nonporous particles is the number-average particle size for primary particles as the target, and is preferably at least 10 nm but no greater than 500 nm, and more preferably at least 10 nm but no greater than 100 nm.

The amount of filler added is not particularly limited, but is preferably 1 to 100 parts by mass relative to 100 parts by mass of Component A.

### (Flexographic Printing Plate Precursor for Laser Engraving)

A first embodiment of the flexographic printing plate precursor for laser engraving of the present invention comprises a relief-forming layer formed from the resin composition for laser engraving of the present invention.

A second embodiment of the flexographic printing plate precursor for laser engraving of the present invention comprises a crosslinked relief-forming layer formed by crosslinking a relief-forming layer formed from the resin composition for laser engraving of the present invention.

In the present invention, the ‘flexographic printing plate precursor for laser engraving’ means both or one of a flexographic printing plate precursor having a crosslinkable relief-forming layer formed from the resin composition for laser engraving in a state before being crosslinked and a flexographic printing plate precursor in a state in which it is cured by light and/or heat.

The flexographic printing plate precursor for laser engraving of the present invention is preferably a flexographic printing plate precursor having a crosslinkable relief-forming layer cured by heat.

In the present invention, the ‘relief-forming layer’ means a layer in a state before being crosslinked, that is, a layer formed from the resin composition for laser engraving of the present invention, which may be dried as necessary.

In the present invention, the “crosslinked relief-forming layer” refers to a layer obtained by crosslinking the aforementioned relief-forming layer. The crosslinking can be preferably performed by light and/or heat. Moreover, the crosslinking is not particularly limited only if it is a reaction that cures the resin composition, and is a general idea that includes the crosslinked structure by the reaction of Component B with each other, and the reaction of Component B with other Component such as Component A etc. The ‘flexographic printing plate’ is made by laser engraving the flexographic printing plate precursor having the crosslinked relief-forming layer.

Moreover, in the present invention, the ‘relief layer’ means a layer of the flexographic printing plate formed by engraving using a laser, that is, the crosslinked relief-forming layer after laser engraving.

A flexographic printing plate precursor for laser engraving of the present invention comprises a relief-forming layer formed from the resin composition for laser engraving of the present invention, which has the above-mentioned components. The relief-forming layer is preferably provided above a support.

The flexographic printing plate precursor for laser engraving may further comprise, as necessary, an adhesive layer between the support and the relief-forming layer and, above the relief-forming layer, a slip coat layer and a protection film.

### <Relief-Forming Layer>

The relief-forming layer is a layer formed from the resin composition for laser engraving of the present invention, and is crosslinkable.

As a mode in which a flexographic printing plate is prepared using the flexographic printing plate precursor for laser engraving, a mode in which a flexographic printing plate is prepared by crosslinking a relief-forming layer to thus form a flexographic printing plate precursor having a crosslinked relief-forming layer, and the crosslinked relief-forming layer (hard relief-forming layer) is then laser-engraved to thus form a relief layer is preferable. By crosslinking the relief-forming layer, it is possible to prevent abrasion of the relief layer during printing, and it is possible to obtain a flexographic printing plate having a relief layer with a sharp shape after laser engraving.

The relief-forming layer may be formed by molding the resin composition for laser engraving that has the above-mentioned components for a relief-forming layer into a sheet shape or a sleeve shape. The relief-forming layer is usually provided above a support, which is described later, but it may be formed directly on the surface of a member such as a cylinder of equipment for plate producing or printing or may be placed and immobilized thereon, and a support is not always required.

A case in which the relief-forming layer is mainly formed in a sheet shape is explained as an example below.

### <Support>

A material used for the support of the flexographic printing plate precursor for laser engraving is not particularly limited, but one having high dimensional stability is preferably used, and examples thereof include metals such as steel, stainless steel, or aluminum, plastic resins such as a polyester (e.g. polyethylene terephthalate (PET), polybutylene terephthalate (PBT), or polyacrylonitrile (PAN)) or polyvinyl chloride, synthetic rubbers such as styrene-butadiene rubber, and glass fiber-reinforced plastic resins (epoxy resin, phenolic resin, etc.). As the support, a PET film or a steel substrate is preferably used. The configuration of the support depends on whether the relief-forming layer is in a sheet shape or a sleeve shape.

### <Adhesive Layer>

An adhesive layer may be provided between the relief-forming layer and the support for the purpose of strengthening the adhesion between the two layers. Examples of materials (adhesives) that can be used in the adhesive layer include those described in ‘Handbook of Adhesives’, Second Edition, Ed by I. Skeist, (1977).

### <Protection Film, Slip Coat Layer>

For the purpose of preventing scratches or dents in the relief-forming layer surface or the crosslinked relief-forming layer surface, a protection film may be provided on the relief-forming layer surface or the crosslinked relief-forming layer surface. The thickness of the protection film is preferably 25 to 500 μm, and more preferably 50 to 200 μm. The protection film may employ, for example, a polyester-based film such as PET or a polyolefin-based film such as PE (polyethylene) or PP (polypropylene). The surface of the film may be made matte. The protection film is preferably peelable.

When the protection film is not peelable or conversely has poor adhesion to the relief-forming layer, a slip coat layer may be provided between the two layers. The material used in the slip coat layer preferably employs as a main component a resin that is soluble or dispersible in water and has little tackiness, such as polyvinyl alcohol, polyvinyl acetate, partially saponified polyvinyl alcohol, a hydroxyalkylcellulose, an alkylcellulose, or a polyamide resin.

### (Process for Producing Flexographic Printing Plate Precursor for Laser Engraving)

The process for producing a flexographic printing plate precursor for laser engraving is not particularly limited, and examples thereof include a method in which a coating solution of a resin composition for laser engraving is prepared, solvent is removed from this coating solution composition for laser engraving, and it is then melt-extruded onto a support. Alternatively, a method may be employed in which a resin composition for laser engraving is cast onto a support, and this is dried in an oven to thus remove solvent from the resin composition.

Among them, the process for producing a flexographic printing plate precursor for laser engraving of the present invention is preferably a production process comprising a layer formation step of forming a relief-forming layer from the resin composition for laser engraving of the present invention and a crosslinking step of crosslinking the relief-forming layer by means of heat and/or light to thus obtain a flexographic printing plate precursor having a crosslinked relief-forming layer, and more preferably a production process comprising a layer formation step of forming a relief-forming layer from the resin composition for laser engraving of the present invention and a crosslinking step of crosslinking the relief-forming layer by means of heat to thus obtain a flexographic printing plate precursor having a crosslinked relief-forming layer.

Subsequently, as necessary, a protection film may be laminated on the relief-forming layer. Laminating may be carried out by compression-bonding the protection film and the relief-forming layer by means of heated calendar rollers, etc. or putting a protection film into intimate contact with a relief-forming layer whose surface is impregnated with a small amount of solvent.

When a protection film is used, a method in which a relief-forming layer is first layered on a protection film and a support is then laminated may be employed.

When an adhesive layer is provided, it may be dealt with by use of a support coated with an adhesive layer. When a slip coat layer is provided, it may be dealt with by use of a protection film coated with a slip coat layer.

### <Layer Formation Step>

The process for producing the flexographic printing plate precursor for laser engraving of the present invention preferably comprises a layer formation step of forming a relief-forming layer from the resin composition for laser engraving of the present invention.

Preferred examples of a method for forming the relief-forming layer include a method in which the resin composition for laser engraving of the present invention is prepared, solvent is removed as necessary from this resin composition for laser engraving, and it is then melt-extruded onto a support and a method in which the resin composition for laser engraving of the present invention is cast onto a support, and this is dried in an oven to thus remove solvent.

The resin composition for laser engraving may be preferably produced by, for example, dissolving or dispersing Components A to C, and optional components in an appropriate solvent.

The thickness of the relief-forming layer in the flexographic printing plate precursor for laser engraving is preferably 0.05 to 10 mm before and after crosslinking, more preferably 0.05 to 7 mm, and yet more preferably 0.05 to 3 mm.

### <Crosslinking Step>

The process for producing a flexographic printing plate precursor for laser engraving of the present invention is preferably a production process comprising a crosslinking step of crosslinking the relief-forming layer by means of heat to thus obtain a flexographic printing plate precursor having a crosslinked relief-forming layer.

When the relief-forming layer comprises a photopolymerization initiator, the relief-forming layer may be crosslinked by irradiating the relief-forming layer with actinic radiation that triggers the photopolymerization initiator.

It is preferable to apply light to the entire surface of the relief-forming layer. Examples of the light (also called ‘actinic radiation’) include visible light, UV light, and an electron beam, but UV light is most preferably used. When the side where there is a substrate, such as a relief-forming layer support, for fixing the relief-forming layer, is defined as the reverse face, only the front face need to be irradiated with light, but when the support is a transparent film through which actinic radiation passes, it is preferable to further irradiate from the reverse face with light as well. When a protection film is present, irradiation from the front face may be carried out with the protection film as it is or after peeling off the protection film. Since there is a possibility of polymerization being inhibited in the presence of oxygen, irradiation with actinic radiation may be carried out after superimposing a polyvinyl chloride sheet on the relief-forming layer and evacuating.

When the relief-forming layer comprises thermal polymerization initiator (the photopolymerization initiator can also be a thermal polymerization initiator.), the relief-forming layer may be crosslinked by heating the flexographic printing plate precursor for laser engraving (step of crosslinking by means of heat). As heating means for carrying out crosslinking by heat, there can be cited a method in which a printing plate precursor is heated in a hot air oven or a far-infrared oven for a predetermined period of time and a method in which it is put into contact with a heated roller for a predetermined period of time.

As a method for crosslinking the relief-forming layer, from the viewpoint of the relief-forming layer being uniformly curable (crosslinkable) from the surface into the interior, crosslinking by heat is preferable.

Due to the relief-forming layer being crosslinked, firstly, a relief formed after laser engraving becomes sharp and, secondly, tackiness of engraving residue formed when laser engraving is suppressed. If an uncrosslinked relief-forming layer is laser-engraved, residual heat transmitted to an area around a laser-irradiated part easily causes melting or deformation of a part that is not targeted, and a sharp relief layer cannot be obtained in some cases. Furthermore, in terms of general properties of a material, the lower the molecular weight, the more easily it becomes a liquid than a solid, that is, there is a tendency for tackiness to increase. Engraving residue formed when engraving a relief-forming layer tends to have higher tackiness as larger amounts of low-molecular-weight materials are used. Since a polymerizable compound, which is a low-molecular-weight material, becomes a polymer by crosslinking, the tackiness of the engraving residue formed tends to decrease.

When the crosslinking step is a step of carrying out crosslinking by light, although equipment for applying actinic radiation is relatively expensive, since a printing plate precursor does not reach a high temperature, there are hardly any restrictions on starting materials for the printing plate precursor.

When the crosslinking step is a step of carrying out crosslinking by heat, although there is the advantage that particularly expensive equipment is not needed, since a printing plate precursor reaches a high temperature, it is necessary to carefully select the starting materials used while taking into consideration the possibility that a thermoplastic polymer, which becomes soft at high temperature, will deform during heating, etc.

During thermal crosslinking, it is preferable to add a thermopolymerization initiator. As the thermopolymerization initiator, a commercial thermopolymerization initiator for free radical polymerization may be used. Examples of such a thermopolymerization initiator include an appropriate peroxide, hydroperoxide, and azo group-containing compound. A representative vulcanizing agent may also be used for crosslinking. Thermal crosslinking may also be carried out by adding a heat-curable resin such as for example an epoxy resin as a crosslinking component to a layer.

### (Flexographic Printing Plate and Process for Making Same)

The process for making a flexographic printing plate of the present invention preferably comprises an engraving step of laser-engraving the flexographic printing plate precursor having the crosslinked relief-forming layer crosslinked the relief-forming layer from the resin composition for laser engraving of the present invention by means of heat and/or light, and more preferably comprises an engraving step of laser-engraving the flexographic printing plate precursor having the crosslinked relief-forming layer crosslinked the relief-forming layer from the resin composition for laser engraving of the present invention by means of heat.

The flexographic printing plate of the present invention is a flexographic printing plate having a relief layer obtained by crosslinking and laser-engraving a layer formed from the resin composition for laser engraving of the present invention, and is preferably a flexographic printing plate made by the process for producing a flexographic printing plate of the present invention.

The flexographic printing plate of the present invention may suitably employ an aqueous ink when printing.

The layer formation step and the crosslinking step in the process for producing a flexographic printing plate of the present invention mean the same as the layer formation step and the crosslinking step in the above-mentioned process for producing a flexographic printing plate precursor for laser engraving, and preferred ranges are also the same.

### <Engraving Step>

The process for producing a flexographic printing plate of the present invention preferably comprises an engraving step of laser-engraving the flexographic printing plate precursor having a crosslinked relief-forming layer.

The engraving step is a step of laser-engraving a crosslinked relief-forming layer that has been crosslinked in the crosslinking step to thus form a relief layer. Specifically, it is preferable to engrave a crosslinked relief-forming layer that has been crosslinked with laser light according to a desired image, thus forming a relief layer. Furthermore, a step in which a crosslinked relief-forming layer is subjected to scanning irradiation by controlling a laser head using a computer in accordance with digital data of a desired image can preferably be cited.

This engraving step preferably employs an infrared laser (an IR laser). When irradiated with an infrared laser, molecules in the crosslinked relief-forming layer undergo molecular vibration, thus generating heat. When a high power laser such as a carbon dioxide laser or a YAG laser is used as the infrared laser, a large quantity of heat is generated in the laser-irradiated area, and molecules in the crosslinked relief-forming layer undergo molecular scission or ionization, thus being selectively removed, that is, engraved. The advantage of laser engraving is that, since the depth of engraving can be set freely, it is possible to control the structure three-dimensionally. For example, for an area where fine halftone dots are printed, carrying out engraving shallowly or with a shoulder prevents the relief from collapsing due to printing pressure, and for a groove area where a fine outline character is printed, carrying out engraving deeply makes it difficult for ink the groove to be blocked with ink, thus enabling breakup of an outline character to be suppressed.

In particular, when engraving is carried out using an infrared laser that corresponds to the absorption wavelength of the photothermal conversion agent, it becomes possible to selectively remove the crosslinked relief-forming layer at higher sensitivity, thus giving a relief layer having a sharp image.

As the infrared laser used in the engraving step, from the viewpoint of productivity, cost, etc., a carbon dioxide laser (a CO₂ laser) or a semiconductor laser is preferable. In particular, a fiber-coupled semiconductor infrared laser (FC-LD) is preferably used. In general, compared with a CO₂ laser, a semiconductor laser has higher efficiency laser oscillation, is less expensive, and can be made smaller. Furthermore, it is easy to form an array due to the small size. Moreover, the shape of the beam can be controlled by treatment of the fiber.

With regard to the semiconductor laser, one having a wavelength of 700 to 1,300 nm is preferable, one having a wavelength of 800 to 1,200 nm is more preferable, one having a wavelength of 860 to 1,200 nm is yet more preferable, and one having a wavelength of 900 to 1,100 nm is particularly preferable.

Furthermore, the fiber-coupled semiconductor laser can output laser light efficiently by being equipped with optical fiber, and this is effective in the engraving step in the present invention. Moreover, the shape of the beam can be controlled by treatment of the fiber. For example, the beam profile may be a top hat shape, and energy can be applied stably to the plate face. Details of semiconductor lasers are described in ‘Laser Handbook 2^{nd} Edition’ The Laser Society of Japan, Applied Laser Technology, The Institute of Electronics and Communication Engineers, etc.

Moreover, as plate making equipment comprising a fiber-coupled semiconductor laser that can be used suitably in the process for making a flexographic printing plate employing the flexographic printing plate precursor of the present invention, those described in detail in JP-A-2009-172658 and JP-A-2009-214334 can be cited. Such equipment comprising a fiber-coupled semiconductor laser can be used to produce a flexographic printing plate of the present invention.

The process for producing a flexographic printing plate of the present invention may as necessary further comprise, subsequent to the engraving step, a rinsing step, a drying step, and/or a post-crosslinking step, which are shown below.

Rinsing step: a step of rinsing the engraved surface by rinsing the engraved relief layer surface with water or a liquid comprising water as a main component.

Drying step: a step of drying the engraved relief layer.

Post-crosslinking step: a step of further crosslinking the relief layer by applying energy to the engraved relief layer.

After the above-mentioned step, since engraved residue is attached to the engraved surface, a rinsing step of washing off engraved residue by rinsing the engraved surface with water or a liquid comprising water as a main component may be added. Examples of rinsing means include a method in which washing is carried out with tap water, a method in which high pressure water is spray-jetted, and a method in which the engraved surface is brushed in the presence of mainly water using a batch or conveyor brush type washout machine known as a photosensitive resin letterpress plate processor, and when slime due to engraved residue cannot be eliminated, a rinsing liquid to which a soap or a surfactant is added may be used.

When the rinsing step of rinsing the engraved surface is carried out, it is preferable to add a drying step of drying an engraved relief-forming layer so as to evaporate rinsing liquid.

Furthermore, as necessary, a post-crosslinking step for further crosslinking the relief-forming layer may be added. By carrying out a post-crosslinking step, which is an additional crosslinking step, it is possible to further strengthen the relief formed by engraving.

The pH of the rinsing liquid that can be used in the present invention is preferably at least 9, more preferably at least 10, and yet more preferably at least 11. The pH of the rinsing liquid is preferably no greater than 14, more preferably no greater than 13.5, and yet more preferably no greater than 13.2. When in the above-mentioned range, handling is easy.

In order to set the pH of the rinsing liquid in the above-mentioned range, the pH may be adjusted using an acid and/or a base as appropriate, and the acid or base used is not particularly limited.

The rinsing liquid that can be used in the present invention preferably comprises water as a main component.

The rinsing liquid may contain as a solvent other than water a water-miscible solvent such as an alcohol, acetone, or tetrahydrofuran.

The rinsing liquid preferably comprises a surfactant.

From the viewpoint of removability of engraved residue and little influence on a flexographic printing plate, preferred examples of the surfactant that can be used in the present invention include betaine compounds (amphoteric surfactants) such as a carboxybetaine compound, a sulfobetaine compound, a phosphobetaine compound, an amine oxide compound, and a phosphine oxide compound.

Furthermore, examples of the surfactant also include known anionic surfactants, cationic surfactants, amphoteric surfactant, and nonionic surfactants. Moreover, a fluorine-based or silicone-based nonionic surfactant may also be used in the same manner.

With regard to the surfactant, one type may be used on its own or two or more types may be used in combination.

It is not necessary to particularly limit the amount of surfactant used, but it is preferably 0.01 to 20 mass % relative to the total mass of the rinsing liquid, and more preferably 0.05 to 10 mass %.

The flexographic printing plate of the present invention having a relief layer above the surface of an optional substrate such as a support may be produced as described above.

From the viewpoint of satisfying suitability for various aspects of printing, such as abrasion resistance and ink transfer properties, the thickness of the relief layer of the flexographic printing plate is preferably at least 0.05 mm but no greater than 10 mm, more preferably at least 0.05 mm but no greater than 7 mm, and yet more preferably at least 0.05 mm but no greater than 3 mm.

Furthermore, the Shore A hardness of the relief layer of the flexographic printing plate is preferably at least 50° but no greater than 90°. When the Shore A hardness of the relief layer is at least 50°, even if fine halftone dots formed by engraving receive a strong printing pressure from a letterpress printer, they do not collapse and close up, and normal printing can be carried out. Furthermore, when the Shore A hardness of the relief layer is no greater than 90°, even for flexographic printing with kiss touch printing pressure it is possible to prevent patchy printing in a solid printed part.

The Shore A hardness in the present specification is a value measured by a durometer (a spring type rubber hardness meter) that presses an indenter (called a pressing needle or indenter) into the surface of a measurement target at 25° C. so as to deform it, measures the amount of deformation (indentation depth), and converts it into a numerical value.

The flexographic printing plate of the present invention is particularly suitable for printing by a flexographic printer using an aqueous ink, but printing is also possible when it is carried out by a letterpress printer using any of aqueous, oil-based, and UV inks, and printing is also possible when it is carried out by a flexographic printer using a UV ink. The flexographic printing plate of the present invention has excellent rinsing properties, there is no engraved residue, and has excellent printing durability, and printing can be carried out for a long period of time without plastic deformation of the relief layer or degradation of printing durability.

### EXAMPLES

The present invention is explained in further detail below by reference to Examples, but the present invention should not be construed as being limited to these Examples. Furthermore, ‘parts’ in the description below means ‘parts by mass’, and % means ‘% by mass’, unless otherwise specified.

Moreover, the number-average molecular weight (Mn) and the weight-average molecular weight (Mw) of a polymer in the Examples are values measured by a GPC method and calculating relative to styrene samples having known molecular weights unless otherwise specified.

### (Component A)

Component A-1: polylactic acid (Aldrich), Tg=50° C., weight-average molecular weight=60,000)
Component A-2: PMMA-b-PBA-b-PMMA block copolymer (poly(methyl methacrylate)-b-poly(n-butyl acrylate)-b-poly(methyl methacrylate) block copolymer) (Kuraray Co., Ltd., KURARITY LA2250), Tg=−30° C., 100° C., weight-average molecular weight 67,000)<

### <Synthesis of A-3>

Under an atmosphere of nitrogen and conditions of −20° C., α-methylstyrene (aMSt, 20 mmol) and 1,1-diphenylhexyllithium (0.5 mmol) were mixed and stirred for 3 hours. Subsequently, n-butyl acrylate (BA, 60 mmol) was added thereto, stirring was carried out at −20° C. for 4 hours, αMSt (20 mmol) was then further added thereto, and stirring was carried out at −20° C. for 2 hours. The polymer (A-3) thus obtained was used in the Examples without further treatment (weight-average molecular weight: 12,000, two Tgs of −36° C. and 110° C.).

A-4: SBR (styrene butadiene rubber) (JSR, TR2000), Tg=−50° C., 100° C., weight-average molecular weight=56,000
A-5: polybutylene succinate (Showa Denko K.K., Bionolle 1020MD), Tg=35° C., weight-average molecular weight=39,000
A-6: liquid polyisoprene (Kuraray Co., Ltd., LIR-30), Tg=−40° C., weight-average molecular weight=28,000

Evaluation of the depolymerizability of A-1 to A-6 above was carried out as follows. With regard to A-1 to A-5 (all being solid), a 1 wt % THF solution was prepared, applied onto a smooth aluminum substrate, and dried at room temperature for 24 hours to form a film, thus giving a measurement sample. With regard to A-6 (liquid), A-6 was poured into an aluminum cup and this was used as a measurement sample. A carbon dioxide laser used here was the same as that used for the evaluation of engraving sensitivity below, engraving conditions also being the same.

TABLE 1

| | | | | mass % of starting |
|---|---|---|---|---|
| | | weight- | | monomer or cyclic |
| | | average | | oligomer of the |
| | | molecular | Tg | monomer relative to the |
| | | weight | (° C.) | total mass of the residue |
| A-1 | polylactic acid | 60,000 | 50° C. | 85 mass % |
| | | | | (depolymerizable) |
| A-2 | PMMA-b- | 67,000 | −30° C., | 78 mass % |
| | PBA-b-PMMA | | 100° C. | (depolymerizable) |
| A-3 | PαMSt-b-PBA- | 12,000 | −36° C., | 60 mass % |
| | b-PαMSt | | 110° C. | (depolymerizable) |
| A-4 | SBR | 56,000 | −50° C., | 5 mass % |
| | | | 100° C. | (nondepolymerizable) |
| A-5 | polybutylene | 39,000 | 35° C. | 10 mass % |
| | succinate | | | (nondepolymerizable) |
| A-6 | polyisoprene | 28,000 | −40° C. | 7 mass % |
| | | | | (nondepolymerizable) |

### <Synthesis of B-1>

A 3-necked flask equipped with a condenser was charged with lactic acid (Wako Pure Chemical Industries, Ltd.) (75 mole), 4-carboxybutanol (25 mole), and DBTDL (Tokyo Chemical Industry Co., Ltd.) (0.05 mole) and heated at 170° C. for 6 hours while stirring. Subsequently, it was cooled to 80° C., 0.1 mole of Duranate TPA-100 (isocyanurate type polyisocyanate, Asahi Kasei) was then added thereto, stirring was carried out for 5 hours, subsequently 0.1 mole of chloromethyloxirane (Wako Pure Chemical Industries, Ltd.) was added, and stirring was carried out for 3 hours. It was cooled to room temperature, thus giving high viscosity liquid B-1 (physical properties shown in Table 2).

### <Synthesis of B-2>

A 3-necked flask equipped with a condenser was charged with lactic acid (Wako Pure Chemical Industries, Ltd.) (75 mole), 4-carboxybutanol (25 mole), and DBTDL (Tokyo Chemical Industry Co., Ltd.) (0.05 mole) and heated at 170° C. for 6 hours while stirring. Subsequently, it was cooled to 80° C., 0.1 mole of trimethylolpropane (Tokyo Chemical Industry Co., Ltd.) was then added thereto, stirring was carried out for 7 hours, subsequently 0.1 mole of trimellitic acid (Wako Pure Chemical Industries, Ltd.) was added, and stirring was carried out for 10 hours. It was cooled to room temperature, thus giving high viscosity liquid B-2 (physical properties shown in Table 2).

### <Synthesis of B-3>

A 3-necked flask equipped with a condenser was charged with methyl methacrylate (Wako Pure Chemical Industries, Ltd.) (6 mole), 4-cyano-4-(phenylcarbonothioylthio)pentanoic acid (Aldrich) (0.05 mole), 4,4′-azobis-4-cyanovaleric acid (Otsuka Chemical Co., Ltd.) (0.05 mole), and methyl ethyl ketone (4 L) and heated at 75° C. for 6 hours while stirring.

Subsequently butyl acrylate (4 mole) and 4,4′-azobis-4-cyanovaleric acid (0.1 mole) were added thereto, and stirring was carried out for 10 hours. The reaction mixture thus obtained was cooled to room temperature, 50 mL of an aqueous solution of sodium hydroxide (1 M) was then added thereto, and heating was carried out at 40° C. for 1 hour. Methyl ethyl ketone was removed from the solution thus obtained by distillation under reduced pressure, a separation was carried out using ethyl acetate and distilled water, the ethyl acetate phase was recovered, and ethyl acetate was removed by distillation under reduced pressure. The oily liquid thus obtained was placed in a 3-necked flask (equipped with a condenser), Karenz MOI (Showa Denko K.K.) (0.01 mole) was further added thereto, and stirring was carried out at 60° C. for 5 hours. Subsequently, glycidyl methacrylate (Wako Pure Chemical Industries, Ltd.) (0.01 mole) was added thereto, and stirring was carried out at 80° C. for 3 hours.

The reaction mixture was cooled, thus giving the target high viscosity liquid B-3 (physical properties shown in Table 2).

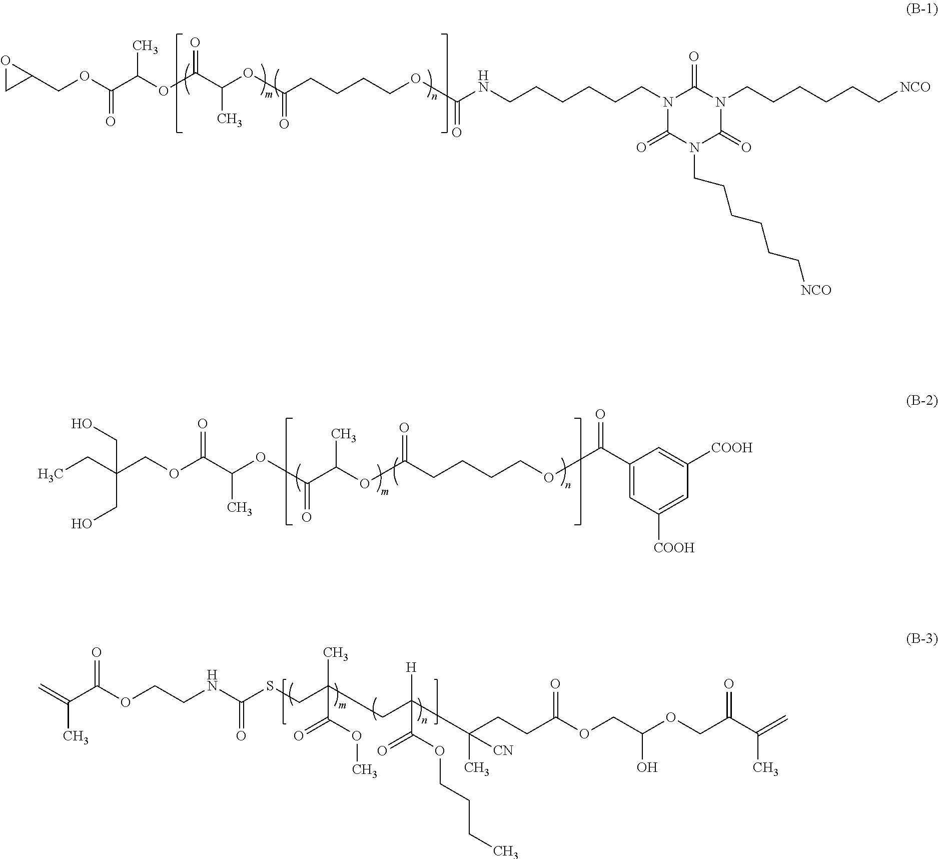

B-4: ethylene glycol dimethacrylate, (Shin-Nakamura Chemical Co., Ltd., NK ester 1 G)
B-5: EBECRYL 450, Cytec, main chain terminal radically polymerizable group-containing polyester oligomer
B-6: Duranate TPA-100, Asahi Kasei, isocyanurate type polyisocyanate

Evaluation of the depolymerizability of Component B-1 to Component B-6 above was carried out in the same manner as for the binder polymer.

TABLE 2

| | | | | | mass % of starting |
|---|---|---|---|---|---|
| | | | | | monomer or cyclic |
| | | weight- | | Repeating | oligomer of the |
| | | average | | unit | monomer relative to |
| | | molecular | Tg | content | the total mass of |
| | | weight | (° C.) | (mass %) | the residue |
| B-1 | — | 5,000 | 15° C. | 75 | 80 mass % |
| | | | | | (depolymerizable) |
| B-2 | — | 8,200 | 10° C. | 86 | 78 mass % |
| | | | | | (depolymerizable) |
| B-3 | — | 9,000 | 0° C. | 90 | 70 mass % |
| | | | | | (depolymerizable) |
| B-4 | ethylene glycol | 198 | none | 31 | 8 mass % |
| | dimethacrylate | | (low | | (nondepolymerizable) |
| | | | molecular | | |
| | | | weight) | | |
| B-5 | main chain terminal | 8,600 | difficult | 90 | 12 mass % |
| | radically polymerizable | | to detect | | (nondepolymerizable) |
| | group-containing | | in DSC | | |
| | polyester oligomer | | (liquid) | | |
| | EBECRYL 450 | | | | |
| B-6 | Duranate TPA- | 505 | difficult | 0 | 0 mass % |
| | 100 | | to detect | | (nondepolymerizable) |
| | | | in DSC | | |
| | | | (liquid) | | |

‘Repeating unit content’ in Table 2 means the content of a polymer moiety in the molecule.

### <Polymerization Initiator>

DBTDL: dibutyltin dilaurate, Tokyo Chemical Industry Co., Ltd.
PBZ: Perbutyl Z, NOF Corporation, t-butyl peroxybenzoate
(Component C) photothermal conversion agent
C-1: ADS820H0, American Dye Source, Inc., hydroxy value: 2.69 meq/g
C-2: ADS817BI, American Dye Source, Inc., hydroxy value: 0 meq/g
C-3: Aqua-Black 162, Tokai Carbon Co., Ltd., self-dispersing type carbon black in which surface functional group is a carboxy group

### Example 1

### 1. Preparation of Resin Composition for Laser Engraving

A three-necked flask equipped with a stirring blade and a condenser was charged with 50 parts of A-1 as Component A and, as a solvent, 10 parts of methylethylketone, and heated at 40° C. for 120 minutes while stirring to thus dissolve the polymer. Subsequently, the solution was set at 70° C., 25 parts of B-1 as Component B and 5 parts of DBTDL as Component D were added, and stirring was carried out for 30 minutes. As a result of the above operations, flowable coating solution 1 for a crosslinkable relief-forming layer (resin composition 1 for laser engraving) was obtained.

### 2. Preparation of Flexographic Printing Plate Precursor for Laser Engraving

A spacer (frame) having a predetermined thickness was placed on a PET substrate, and the coating solution 1 for a crosslinkable relief-forming layer obtained above was cast gently so that it did not overflow from the spacer (frame) and dried in an oven at 70° C. for 3 hours. Subsequently, heating was carried out at 120° C. for 3 hours and at 150° C. for a further 3 hours to thus thermally crosslink the relief-forming layer to provide a relief-forming layer having a thickness of about 1 mm, thereby preparing flexographic printing plate precursor 1 for laser engraving.

### 3. Making Flexographic Printing Plate

The relief-forming layer after crosslinking (crosslinked relief-forming layer) was engraved using the two types of laser below.

As a carbon dioxide laser engraving machine, for engraving by irradiation with a laser, an ML-9100 series high quality CO₂ laser marker (Keyence) was used. A 1 cm square solid printed part was raster-engraved using the carbon dioxide laser engraving machine under conditions of an output of 12 W, a head speed of 200 mm/sec, and a pitch setting of 2,400 DPI.

As a semiconductor laser engraving machine, laser recording equipment provided with an SDL-6390 fiber-coupled semiconductor laser (FC-LD) (JDSU, wavelength 915 nm) with a maximum power of 8.0 W was used. A 1 cm square solid printed part was raster-engraved using the semiconductor laser engraving machine under conditions of a laser output of 7.5 W, a head speed of 409 mm/sec, and a pitch setting of 2,400 DPI.

The thickness of the relief layer of the flexographic printing plate was about 1 mm.

Furthermore, the Shore A hardness of the relief layer measured by the measurement method above was 75°.

### Examples 2 to 8 and Comparative Examples 1 to 6

### 1. Preparation of Crosslinkable Resin Composition for Laser Engraving

Coating solutions for a crosslinkable relief-forming layer (resin compositions for laser engraving) 2 to 8 and comparative coating solutions for a crosslinkable relief-forming layer (resin compositions for laser engraving) 1 to 6 were prepared in the same manner as in Example 1 except that Component A to Component C used in Example 1 and Component D below were changed as described in Table 3 below. In addition, 5 parts of the photothermal conversion agent (Component C) was added together with Component A and Component B.

Furthermore, the crosslinking catalyst (DBTDL) used in Example 1 and Examples 4 to 8 functions also as a depolymerization catalyst during laser engraving, which is described later.

### 2. Preparation of Flexographic Printing Plate Precursors for Laser Engraving

Flexographic printing plate precursors 2 to 8 for laser engraving of the Examples and flexographic printing plate precursors 1 to 6 for laser engraving of the Comparative Examples were prepared in the same manner as in Example 1 except that coating solution 1 for a crosslinkable relief-forming layer in Example 1 was changed to coating solutions 2 to 8 for a crosslinkable relief-forming layer and comparative coating solutions 1 to 6 for a crosslinkable relief-forming layer.

### 3. Preparation of Flexographic Printing Plates

Flexographic printing plates 2 to 8 of the Examples and flexographic printing plates 1 to 6 of the Comparative Examples were obtained by subjecting the relief-forming layers of flexographic printing plate precursors 2 to 8 for laser engraving of the Examples and flexographic printing plate precursors 1 to 6 for laser engraving of the Comparative Examples to thermal crosslinking and then engraving to form a relief layer as in Example 1.

The thickness of the relief layers of these flexographic printing plates was about 1 mm.

Furthermore, the Shore A hardness of the relief layer measured by the measurement method above was 75°.

### <Evaluation of Flexographic Printing Plates>

Evaluation of the performance of the flexographic printing plates was carried out in terms of the items below, and the results are shown in Table 3. With regard to evaluations other than engraving depth, the evaluation results when engraving was carried out using a carbon dioxide laser and the evaluation results when engraving was carried out using a semiconductor laser were the same.

### (1) Mass % of Starting Monomer or Cyclic Oligomer of Starting Monomer

(i) Gaseous residue and (ii) solid or liquid engraving residue remaining on a printing plate, generated when laser engraving using a carbon dioxide Laser Marker, were individually analyzed, and the proportion of starting monomer or cyclic oligomer of the monomer relative to the total residue mass was determined.

That is, when the total mass of an engraved portion (portion that has been engraved and removed) is X, and the total mass of the starting monomer or cyclic oligomer of the monomer that was actually measured is Y, the mass % (Z) of the starting monomer or cyclic oligomer of the starting monomer is given by the equation below.

Z═Y/X×100

Analysis of the gaseous residue and analysis of the solid or liquid engraving residue remaining on a printing plate were carried out as follows.

### Analysis of Gaseous Residue

Gaseous residue was collected using the equipment below.

Suction box for sampling (Ohmi Oder Air Service)

Collection bag (10 L, Ohmi Oder Air Service)

Collection conditions for gaseous residue were as follows.

Gas sampling atmosphere: under an atmosphere of air

Gas collection time: 5 min.

Total amount of gas collected: 3 L

Collected gas was analyzed using gas chromatography under the conditions below.

The amount of starting monomer or cyclic oligomer of the monomer was calculated based on a calibration curve formed by measuring an authentic sample of the starting monomer or cyclic oligomer of the monomer (readily available (purchased)) using gas chromatography.

### Conditions

Measurement equipment: GC-3200 (G L Sciences Inc.)

Column: APS-1000 (Teflon 3 ×6 m) (G L Sciences Inc.)

Column temperature: 250° C.

Carrier gas: hydrogen (hydrogen gas generator: HG260B, G L Sciences Inc.)

Amount injected: 1 μL

### Analysis of Solid or Liquid Engraving Residue Remaining on Printing Plate

1 mg of solid or liquid engraving residue remaining on a printing plate was sampled using a spatula and dispersed in 5 mL of tetrahydrofuran (THF), thus giving a sample for high performance liquid chromatography (HPLC) measurement.

The amount of starting monomer or cyclic oligomer of the monomer in the measurement sample was calculated based on a calibration curve formed by measuring an authentic sample of the starting monomer or cyclic oligomer of the monomer (readily available (purchased)) using HPLC under the conditions below. The amount of starting monomer or cyclic oligomer of the monomer relative to the total amount of solid or liquid engraving residue remaining on a printing plate generated when laser engraving using a carbon dioxide Laser Marker was determined by calculation based on the amount of starting monomer or cyclic oligomer of monomer in the measurement sample.

### Conditions

Measurement equipment: HPLC (Shimadzu Corporation)

Column: Shim-pack CLC-ODS, 6.0×150 mm

Column temperature: 40° C.

Eluent: acetonitrile/ion-exchanged water (phosphoric acid, triethylamine each added at 0.2%)=80/20

Flow rate: 1 mL/min

Detection wavelength: 210 nm

Measurement time: 10 min

Amount injected: 1 μL

The laser engraving machine and conditions were as in the method above.

### (3) Measurement of Engraving Depth

The ‘engraving depth’ of a relief layer obtained by laser-engraving the relief-forming layer of the obtained flexographic printing plate precursors using a carbon dioxide laser or a semiconductor laser (IR laser) was measured as follows. The ‘engraving depth’ referred to here means the difference between an engraved position (height) and an unengraved position (height) when a cross-section of the relief layer was examined. The ‘engraving depth’ in the present Examples was measured by examining a cross-section of a relief layer using a VK9510 ultradepth color 3D profile measurement microscope (Keyence Corporation). A large engraving depth means a high engraving sensitivity. The results are given in Table 3 for each of the types of laser used for engraving.

### (3) Amount of Residue on Printing Plate

The amount of residue on a printing plate was determined by measuring the amount (mass) of residue remaining on the printing plate relative to the total mass of an engraved portion. The total mass of the engraved portion may be measured from the specific gravity of a crosslinked relief-forming layer, the volume removed by engraving, etc., and the volume removed by engraving may be calculated from the area of laser engraving and the engraving depth.

### (4) Rinsing Properties

A laser-engraved plate was immersed in water and an engraved part was rubbed with a toothbrush (Clinica Toothbrush Flat, Lion Corporation) 10 times. Subsequently, the presence/absence of residue on the surface of the relief layer was ascertained with an optical microscope. When there was no residue the evaluation was A, when there was almost no residue the evaluation was B, when there was some residue but there was no practical problem the evaluation was C, and when the residue could not be removed the evaluation was D.

TABLE 3

| | | | | | mass % of starting | | | | |
|---|---|---|---|---|---|---|---|---|---|
| | Component materials of the | | | | monomer or cyclic | | | Amount of | |
| | printing plate precursor | | | | oligomer of the | engraving | | the | |
| | | | | photothermal | monomer relative to | depth (μm) | | residue on | |
| | | crosslinking | crosslinking | conversion | the total mass of | CO₂ | FC- | a printing | Rinsing |
| | binder | agent | catalyst | agent | the residue | laser | LD | plate (%) | properties |
| Example 1 | A-1 | B-1 | DBTDL | None | 80% | 620 | 0 | 0.5 | B |
| | | | | | (depolymerizable) | | | | |
| Example 2 | A-2 | B-3 | PBZ | None | 75% | 620 | 0 | 0.5 | B |
| | | | | | (depolymerizable) | | | | |
| Example 3 | A-3 | B-3 | PBZ | None | 75% | 620 | 0 | 0.5 | B |
| | | | | | (depolymerizable) | | | | |
| Example 4 | A-1 | B-1 | DBTDL | C-1 | 90% | 650 | 680 | 0.1 | A |
| | | | | | (depolymerizable) | | | | |
| Example 5 | A-1 | B-2 | DBTDL | C-1 | 90% | 680 | 710 | 0.05 | A |
| | | | | | (depolymerizable) | | | | |
| Example 6 | A-1 | B-1 | DBTDL | C-2 | 80% | 620 | 640 | 0.5 | B |
| | | | | | (depolymerizable) | | | | |
| Example 7 | A-1 | B-3 | DBTDL | None | 70% | 600 | 0 | 0.8 | B |
| | | | | | (depolymerizable) | | | | |
| Example 8 | A-1 | B-1 | DBTDL | C-3 | 85% | 640 | 670 | 0.3 | A |
| | | | | | (depolymerizable) | | | | |
| Comp. | A-4 | B-4 | PBZ | None | 10% | 500 | 0 | 10 | D |
| Example 1 | | | | | (nondepolymerizable) | | | | |
| Comp. | A-5 | B-5 | PBZ | None | 12% | 600 | 0 | 4 | C |
| Example 2 | | | | | (nondepolymerizable) | | | | |
| Comp. | A-6 | B-6 | DBTDL | C-1 | 7% | 580 | 620 | 9 | D |
| Example 3 | | | | | (nondepolymerizable) | | | | |
| Comp. | A-2 | B-4 | PBZ | None | 30% | 580 | 0 | 10 | D |
| Example 4 | | | | | (nondepolymerizable) | | | | |
| Comp. | A-1 | B-6 | DBTDL | C-1 | 20% | 590 | 625 | 5 | C |
| Example 5 | | | | | (nondepolymerizable) | | | | |
| Comp. | A-4 | B-3 | PBZ | None | 25% | 500 | 0 | 7 | D |
| Example 6 | | | | | (nondepolymerizable) | | | | |

What is claimed is:

1. A resin composition for laser engraving, comprising:
(Component A) a binder polymer, and
(Component B) a crosslinking agent,
a crosslinked relief-forming layer formed from the composition being depolymerizable.

2. The resin composition for laser engraving according to claim 1, wherein Component A comprises (Component A-1) a depolymerizable binder polymer.

3. The resin composition for laser engraving according to claim 2, wherein Component A-1 comprises any one selected from the group consisting of a polyester resin, a resin containing at least 50 mol % of a (meth)acrylic acid ester as a monomer unit, and a resin containing at least 50 mol % of α-methylstyrene as a monomer unit.

4. The resin composition for laser engraving according to claim 2, wherein Component A-1 is selected from the group consisting of polylactic acid, a poly(methyl methacrylate)-b-poly(butyl acrylate)-b-poly(methyl methacrylate) block copolymer, a poly(α-methylstyrene)-b-poly(butyl acrylate)-b-poly(α-methylstyrene) block copolymer, poly(methyl methacrylate), a methyl methacrylate/2-hydroxyethyl methacrylate copolymer, a methyl methacrylate/allyl methacrylate copolymer, poly(methyl acrylate), a methyl acrylate/2-hydroxyethyl acrylate copolymer, and a methyl acrylate/allyl methacrylate copolymer.

5. The resin composition for laser engraving according to claim 2, wherein Component B comprises (Component B-1) a depolymerizable crosslinking agent.

6. The resin composition for laser engraving according to claim 5, wherein Component B-1 comprises as a crosslinkable group at least one type of group selected from the group consisting of —SiR¹R²R³, an acid anhydride residue, an ethylenically unsaturated group, an isocyanate group, a blocked isocyanate group, an amino group, a hydroxy group, —C(═O)—R⁴, an epoxy group, a carboxylic acid group, and a mercapto group.

7. The resin composition for laser engraving according to claim 5, wherein Component A-1 and Component B-1 have a content in total of 80 to 99 mass % of the total solids content of the resin composition for laser engraving.

8. The resin composition for laser engraving according to claim 5, wherein Component B-1 has a content of 5 to 90 mass % of the total solids content of the resin composition for laser engraving.

9. The resin composition for laser engraving according to claim 1, wherein it further comprises (Component C) a photothermal conversion agent.

10. The resin composition for laser engraving according to claim 9, wherein Component C comprises a group that can form a covalent bond with Component A and/or Component B.

11. The resin composition for laser engraving according to claim 9, wherein Component C is carbon black.

12. The resin composition for laser engraving according to claim 9, wherein Component C has a content of no greater than 10 mass % of the total solids content of the resin composition for laser engraving.

13. The resin composition for laser engraving according to claim 1, wherein it further comprises (Component D) a crosslinking catalyst.

14. The resin composition for laser engraving according to claim 5, wherein it further comprises (Component D) a crosslinking catalyst.

15. The resin composition for laser engraving according to claim 1, wherein it further comprises (Component E) a depolymerization catalyst and/or a depolymerization catalyst precursor.

16. A flexographic printing plate precursor for laser engraving, comprising a crosslinked relief-forming layer formed by crosslinking by means of light and/or heat a relief-forming layer formed from the resin composition for laser engraving according to claim 1.

17. A process for producing a flexographic printing plate precursor for laser engraving, the process comprising:
a layer formation step of forming a relief-forming layer from the resin composition for laser engraving according to claim 1, and
a crosslinking step of crosslinking the relief-forming layer by means of light and/or heat to thus obtain a flexographic printing plate precursor comprising a crosslinked relief-forming layer.

18. The process for producing a flexographic printing plate precursor for laser engraving according to claim 17, wherein the crosslinking step is a step of crosslinking the relief-forming layer by means of heat to thus obtain a flexographic printing plate precursor comprising a crosslinked relief-forming layer.

19. A process for making a flexographic printing plate, the process comprising in order:
a step of preparing a flexographic printing plate precursor for laser engraving comprising a crosslinked relief-forming layer formed by crosslinking by means of light and/or heat a relief-forming layer formed from the resin composition for laser engraving according to claim 1, and
an engraving step of laser engraving the crosslinked relief-forming layer to thus form a relief layer.

20. A flexographic printing plate comprising a relief layer, the flexographic printing plate being made by the process for making a flexographic printing plate according to claim 19.
